(19) United States
(12) Patent Application Publication
(10) Pub. No.: US 2025/0060907 A1
(43) Pub. Date: Feb. 20, 2025

(54) COMPUTER SYSTEM AND OPERATING METHOD THEREOF, MEMORY SYSTEM, CONTROLLER AND STORAGE

(71) Applicant: YANGTZE MEMORY TECHNOLOGIES CO., LTD., Wuhan (CN)

(72) Inventor: Mo CHENG, Wuhan (CN)

(21) Appl. No.: 18/533,613

(22) Filed: Dec. 8, 2023

(30) Foreign Application Priority Data
Aug. 16, 2023 (CN) 2023110354088

(51) Int. Cl. G06F 3/06

(52) U.S. Cl. CPC G06F 3/0659; G06F 3/0604; G06F 3/0679

(57) ABSTRACT

The computer system includes a host, a controller and a memory. The memory space of the memory is divided into at least two types of data partitions. The host is configured to send a write command to the controller. The write command includes first data to be written into the memory and logical unit number into which the first data is to be written. The logical unit number is specified according to the type of the data partition. The controller is configured to instruct the memory to write the first data into a physical memory block corresponding to the logical unit number in the memory according to the logical unit number. A physical memory block corresponding to the first type of the data partition is different from a physical memory block corresponding to the second type of the data partition.

### CROSS-REFERENCE TO RELATED APPLICATIONS

The present application claims priority to Chinese Patent Application No. 2023110354088, which was filed Aug. 16, 2023, is titled “COMPUTER SYSTEM AND ITS OPERATING METHOD, STORAGE SYSTEM, CONTROLLER AND STORAGE MEDIUM,” and is hereby incorporated herein by reference in its entirety.

### TECHNICAL FIELD

The present application relates to the field of memory technologies, for example, a computer system and an operating method thereof, a memory system, a controller and a storage medium.

### BACKGROUND

With the continuous popularization of mobile terminals such as mobile phones, many users may make use of a memory in the mobile phone as a mobile hard disk to store external data of the mobile phone.

### SUMMARY

The present application provides a computer system and an operating method thereof, a memory system, a controller and a storage medium.

In an aspect, it is provided a computer system, comprising: a host, a controller and a memory, wherein memory space of the memory is divided into at least two types of data partitions, the at least two types comprising: a first type corresponding to external data of an electronic device comprising the computer system; and a second type corresponding to internal data of the electronic device; the host is configured to send a write command to the controller, wherein the write command comprises first data to be written into the memory and a logical unit number to which the first data is to be written, and the logical unit number is specified according to the type of the data partition; and the controller is configured to instruct the memory to write the first data into a physical memory block corresponding to the logical unit number in the memory according to the logical unit number, wherein a physical memory block corresponding to the first type of data partition is different from a physical memory block corresponding to the second type of data partition.

In an example, the controller is configured to: determine the physical memory block corresponding to the logical unit number according to the logical unit number; and instruct the memory to write the first data into the physical memory block corresponding to the logical unit number.

In an example, the controller is configured to: obtain data attribute of the first data according to the logical unit number, wherein the data attribute is configured to indicate whether the first data is the external data of the electronic device or the internal data of the electronic device; determine the physical memory block corresponding to the logical unit number in the memory according to the data attribute; and instruct the memory to write the first data into the physical memory block corresponding to the logical unit number.

In an example, a correspondence between the logical unit number and the data attribute of the first data is predefined by an protocol; or the correspondence between the logical unit number and the data attribute of the first data is set when the memory space of the memory is configured as the at least two types of data partitions in the host.

In an example, the controller is configured to, in a case where the data attribute is configured to indicate that the first data is the external data of the electronic device, determine at least one physical memory block satisfying a first condition in the memory as the physical memory block corresponding the logic unit number, the first condition comprising: the physical memory block is not full, and second data is not stored, wherein the second data is data in the second type of data partition; and in a case where the data attribute is configured to indicate that the first data is the internal data of the electronic device, determine at least one physical memory block satisfying a second condition in the memory as the physical memory block corresponding the logic unit number, the second condition comprising: the physical memory block is not full, and third data is not stored, wherein the third data is data in the first type of data partition.

In an example, a correspondence between the type of the data partition and a physical memory block where data in the data partition is located is a non-fixed configuration relationship, and the controller is configured to: in the case where the data attribute is configured to indicate that the first data is the external data of the electronic device, determine at least one physical memory block satisfying the first condition from all writable physical memory blocks of the memory as the physical memory block corresponding to the logical unit number; and in the case where the data attribute is configured to indicate that the first data is the internal data of the electronic device, determine at least one physical memory block satisfying the second condition from all writable physical memory blocks of the memory as the physical memory block corresponding to the logical unit number.

In an example, a correspondence between the type of the data partition and a physical memory block where data in the data partition is located is a fixed configuration relationship, and the controller is configured to: in the case where the data attribute is configured to indicate that the first data is the external data of the electronic device, determine at least one physical memory block that is not full from individual physical memory blocks preconfigured for the first type of data partition as the physical memory block corresponding to the logical unit number; and in the case where the data attribute is configured to indicate that the first data is the internal data of the electronic device, determine at least one physical memory block that is not full from individual physical memory blocks pre-configured for the second type of data partition as the physical memory block corresponding to the logical unit number.

In an example, the controller is further configured to: set a data type of the first data according to the type of the data partition into which the first data is written, and wherein the data type is to manage the first data or the physical memory block where the first data is located.

In an example, the data type comprises: cold data; or hot data.

In an example, the host is further configured to: in a case where the first type of data partition has been loaded, display an unload control on an interactive interface; and in a case where a trigger operation on the unload control is received, unload the first type of data partition in an interface of a resource manager of the host.

In an example, the host is further configured to: in a case where the first type of data partition has not been loaded, display a load control on an interactive interface; and in a case where a trigger operation on the load control is received, load the first type of data partition in an interface of a resource manager of the host.

In an example, the host is further configured to: in response to the electronic device being coupled to an external device via a Universal Serial Bus interface, display a trigger control corresponding to the first type of data partition on an interactive interface; and in a case where a selection operation on the trigger control is received, allow the first type of data partition to be accessed at the external device side.

In another aspect, it is provided a method of operating a computer system, wherein the computer system comprises a host, a controller and a memory, wherein memory space of the memory is divided into at least two types of data partitions, the at least two types comprising: a first type corresponding to external data of an electronic device comprising the computer system; and a second type corresponding to internal data of the electronic device, wherein the method comprises: sending, by the host, a write command to the controller, wherein the write command comprises first data to be written into the memory and a logical unit number to which the first data is to be written, and the logical unit number is specified according to the type of the data partition; and instructing, by the controller, the memory to write the first data into a physical memory block corresponding to the logical unit number in the memory according to the logical unit number, wherein a physical memory block corresponding to the first type of data partition is different from a physical memory block corresponding to the second type of data partition.

In an example, the instructing, by the controller, the memory to write the first data into a physical memory block corresponding to the logical unit number in the memory according to the logical unit number comprises: determining, by the controller, the physical memory block corresponding to the logical unit number according to the logical unit number; and instructing, by the controller, the memory to write the first data into the physical memory block corresponding to the logical unit number.

In an example, the determining, by the controller, the physical memory block corresponding to the logical unit number according to the logical unit number, and instructing, by the controller, the memory to write the first data into the physical memory block corresponding to the logical unit number comprises: obtaining, by the controller, data attribute of the first data according to the logical unit number, wherein the data attribute is configured to indicate whether the first data is the external data of the electronic device or the internal data of the electronic device; determining, by the controller, the physical memory block corresponding to the logical unit number in the memory according to the data attribute; and instructing, by the controller, the memory to write the first data into the physical memory block corresponding to the logical unit number.

In an example, a correspondence between the logical unit number and the data attribute of the first data is predefined by an protocol; or the correspondence between the logical unit number and the data attribute of the first data is set when the memory space of the memory is configured as the at least two types of data partitions in the host.

In an example, the determining, by the controller, the physical memory block corresponding to the logical unit number in the memory according to the data attribute comprises: in a case where the data attribute is configured to indicate that the first data is the external data of the electronic device, determining, by the controller, at least one physical memory block satisfying a first condition in the memory as the physical memory block corresponding the logic unit number, the first condition comprising: the physical memory block is not full, and second data is not stored, wherein the second data is data in the second type of data partition; and in a case where the data attribute is configured to indicate that the first data is the internal data of the electronic device, determining, by the controller, at least one physical memory block satisfying a second condition in the memory as the physical memory block corresponding the logic unit number, the second condition comprising: the physical memory block is not full, and third data is not stored, wherein the third data is data in the first type of data partition.

In an example, a correspondence between the type of the data partition and a physical memory block where data in the data partition is located is a non-fixed configuration relationship, and in a case where the data attribute is configured to indicate that the first data is the external data of the electronic device, determining, by the controller, at least one physical memory block satisfying a first condition in the memory as the physical memory block corresponding the logic unit number comprises: in the case where the data attribute is configured to indicate that the first data is the external data of the electronic device, determining, by the controller, at least one physical memory block satisfying the first condition from all writable physical memory blocks of the memory as the physical memory block corresponding to the logical unit number; and in a case where the data attribute is configured to indicate that the first data is the internal data of the electronic device, determining, by the controller, at least one physical memory block satisfying a second condition in the memory as the physical memory block corresponding the logic unit number comprises: in the case where the data attribute is configured to indicate that the first data is the internal data of the electronic device, determining, by the controller, at least one physical memory block satisfying the second condition from all writable physical memory blocks of the memory as the physical memory block corresponding to the logical unit number.

In an example, a correspondence between the type of the data partition and a physical memory block where data in the data partition is located is a fixed configuration relationship, and in a case where the data attribute is configured to indicate that the first data is the external data of the electronic device, determining, by the controller, at least one physical memory block satisfying a first condition in the memory as the physical memory block corresponding the logic unit number comprises: in the case where the data attribute is configured to indicate that the first data is the external data of the electronic device, determining, by the controller, at least one physical memory block that is not full from individual physical memory blocks preconfigured for the first type of data partition as the physical memory block corresponding to the logical unit number; and in a case where the data attribute is configured to indicate that the first data is the internal data of the electronic device, determining, by the controller, at least one physical memory block satisfying a second condition in the memory as the physical memory block corresponding the logic unit number comprises: in the case where the data attribute is configured to indicate that the first data is the internal data of the electronic device, determining, by the controller, at least one physical memory block that is not full from individual physical memory blocks pre-configured for the second type of data partition as the physical memory block corresponding to the logical unit number.

In an example, the method further comprises: setting, by the controller, a data type of the first data according to the type of the data partition into which the first data is written, and wherein the data type is to manage the first data or the physical memory block where the first data is located.

In an example, the data type comprises: cold data; or hot data.

In an example, the method further comprises: in a case where the first type of data partition has been loaded, displaying, by the host, an unload control on an interactive interface; and in a case where a trigger operation on the unload control is received, unloading, by the host, the first type of data partition in an interface of a resource manager of the host.

In an example, the method further comprises: in a case where the first type of data partition has not been loaded, displaying, by the host, a load control on an interactive interface; and in a case where a trigger operation on the load control is received, loading, by the host, the first type of data partition in an interface of a resource manager of the host.

In an example, the method further comprises: in response to the electronic device being coupled to an external device via a Universal Serial Bus interface, displaying, by the host, a trigger control corresponding to the first type of data partition on an interactive interface; and in a case where a selection operation on the trigger control is received, allowing, by the host, the first type of data partition to be accessed at the external device side.

In another aspect, it is provided a memory system, comprising a controller and a memory. Memory space of the memory is divided into at least two types of data partitions, and the at least two types comprising a first type corresponding to external data of an electronic device comprising a computer system and a second type corresponding to internal data of the electronic device, and wherein the computer system comprises the memory system. The controller is configured to receive a write command comprising first data to be written into the memory and a logical unit number to which the first data is to be written. The logical unit number is specified according to the type of the data partition. The controller is further configured to instruct the memory to write the first data into a physical memory block corresponding to the logical unit number in the memory according to the logical unit number. The physical memory block corresponding to the first type of data partition is different from a physical memory block corresponding to the second type of data partition.

In another aspect, it is provided a controller. The controller comprises a memory interface and a memory controller. The memory interface is configured to connect a host and a memory. Memory space of the memory is divided into at least two types of data partitions. The at least two types comprises a first type corresponding to external data of an electronic device comprising a computer system and a second type corresponding to internal data of the electronic device. The computer system comprises the host, the controller, and the memory. The memory interface is configured to receive a write command sent from the host. The write command comprises first data to be written into the memory and a logical unit number to which the first data is to be written, and the logical unit number is specified according to the type of the data partition. The memory controller is configured to instruct, via the memory interface, the memory to write the first data into a physical memory block corresponding to the logical unit number in the memory according to the logical unit number. The physical memory block corresponding to the first type of data partition is different from a physical memory block corresponding to the second type of data partition.

In another aspect, it is provided a method of operating a memory system. The memory system comprising a controller and a memory. Memory space of the memory is divided into at least two types of data partitions. The at least two types comprises a first type corresponding to external data of an electronic device comprising a computer system and a second type corresponding to internal data of the electronic device. The computer system comprises the memory system. The method is performed by the controller. The method comprises receiving a write command. The write command comprises first data to be written into the memory and a logical unit number to which the first data is to be written. The logical unit number is specified according to the type of the data partition. The method further comprises instructing the memory to write the first data into a physical memory block corresponding to the logical unit number in the memory according to the logical unit number. The physical memory block corresponding to the first type of data partition is different from a physical memory block corresponding to the second type of data partition.

In another aspect, it is provided a computer-readable storage medium having stored therein instructions that, when run on a controller, implement all or part of the operations executed by the controller in the method of operating a computer system as set forth in any of the above-mentioned examples, wherein the controller is the controller in the computer system as described above.

### BRIEF DESCRIPTION OF THE DRAWINGS

In order to more clearly illustrate the technical solutions in the examples of the present application, the drawings that need to be used in the description of the examples will be briefly introduced below. The drawings in the following description are only some examples of the present application. For those skilled in the art, other drawings can also be obtained based on these drawings without creative effort.

FIG. 1 is a schematic diagram of a computer system according to an example of the present application.

FIG. 2 is a schematic structural diagram of a memory card according to an example of the present application.

FIG. 3 is a schematic structural diagram of a solid-state drive according to an example of the present application.

FIG. 4 is a block diagram of a memory shown in an example of the present application.

FIG. 5 is a schematic circuit diagram of a memory shown in an example of the present application.

FIG. 6 is a perspective view of a part of a three-dimensional memory array structure shown in an example of the present application.

FIG. 7 is a schematic diagram of data storage on a physical memory block according to an example of the present application.

FIG. 8 is a frame diagram of a computer system according to an example of the present application.

FIG. 9 is a schematic diagram of data storage on a physical memory block according to an example of the present application.

FIG. 10 is a schematic diagram of a data storage location change according to an example of the present application.

FIG. 11 is a schematic diagram of another data storage location change according to an example of the present application.

FIG. 12 is a schematic diagram of writing setting of external data according to an example of the present application.

FIG. 13 is a schematic diagram of unloading data partition for external data according to an example of the present application.

FIG. 14 is a schematic diagram of loading data partition for external data according to an example of the present application.

FIG. 15 is a schematic diagram of device connections according to an example of the present application.

FIG. 16 is a flow chart of a method of operating a computer system according to an example of the present application.

FIG. 17 is a structural block diagram of a memory system according to an example of the present application.

FIG. 18 is a schematic structural diagram of a controller according to an example of the present application.

FIG. 19 is a flowchart of a method of operating a memory system according to another example of the present application.

### DETAILED DESCRIPTION

Examples of the present application will be further described in detail below in conjunction with the accompanying drawings.

A computer system according to the examples of the present application may include a host and a memory system. The memory system may include a 3D memory, such as a 3D NAND flash.

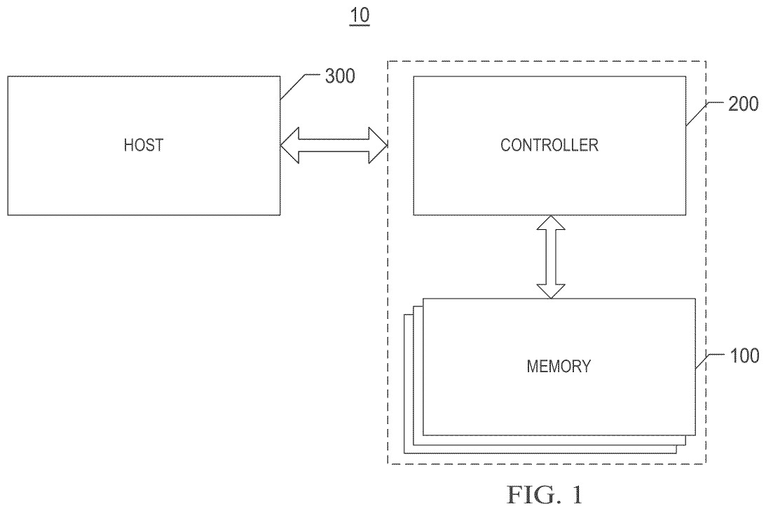

FIG. 1 is a schematic diagram of a computer system according to an example of the present application. As shown in FIG. 1, the computer system 10 includes one or more memories 100, and a controller 200 coupled to the memory 100 and configured to control the memory 100. The controller 200 may also be referred to as a memory controller.

The controller 200 may be configured to control operations performed by the memory 100, such as read, erase and program operations. The controller 200 may also be configured to manage various functions regarding data stored or to be stored in the memory 100, including but not limited to bad block management, garbage collection, logical to physical address translation, wear leveling, and the like. In some examples, the controller 200 may also be configured to process an Error Correcting Code (ECC) of data read from or written into the memory 100. The controller 200 may also perform any other suitable functions, for example, formatting the memory 100.

The controller 200 can also communicate with external devices according to a specific communication protocol. In some examples, the controller 200 may communicate with external devices via at least one of various interface protocols. The interface protocol can be Universal Serial Bus (USB) protocol, Multi-Media Card (MMC) protocol, Peripheral Component Interconnect (PCI) protocol, PCI-Express (PCI-E) protocol, Advanced Technology Attachment (ATA) protocol, Serial ATA protocol, Parallel ATA protocol, Small Computer System Interface (SCSI) protocol, Enhanced Small Drive Interface (ESDI) protocol, Integrated Development Environment (IDE) protocol, Firewire protocol, etc.

In an example, the controller 200 and one or more memories 100 can be integrated into various types of electronic devices. The electronic device may be a mobile phone, a desktop computer, a laptop computer, a tablet computer, a vehicle computer, a game console, a printer, a pointing device, a wearable electronic device, a smart sensor, a virtual reality (VR) device, an Augmented Reality (AR) device or any other suitable electronic device having storage therein. In this scenario, as shown in FIG. 1, the computer system 10 further includes a host 300. The controller 200 is coupled to a host 300. The controller 200 may manage data stored in the memory 100 and communicate with the host 300 to implement functions of the aforementioned electronic devices.

In some other examples, the controller 200 and one or more memories 100 may be integrated into various types of storage devices.

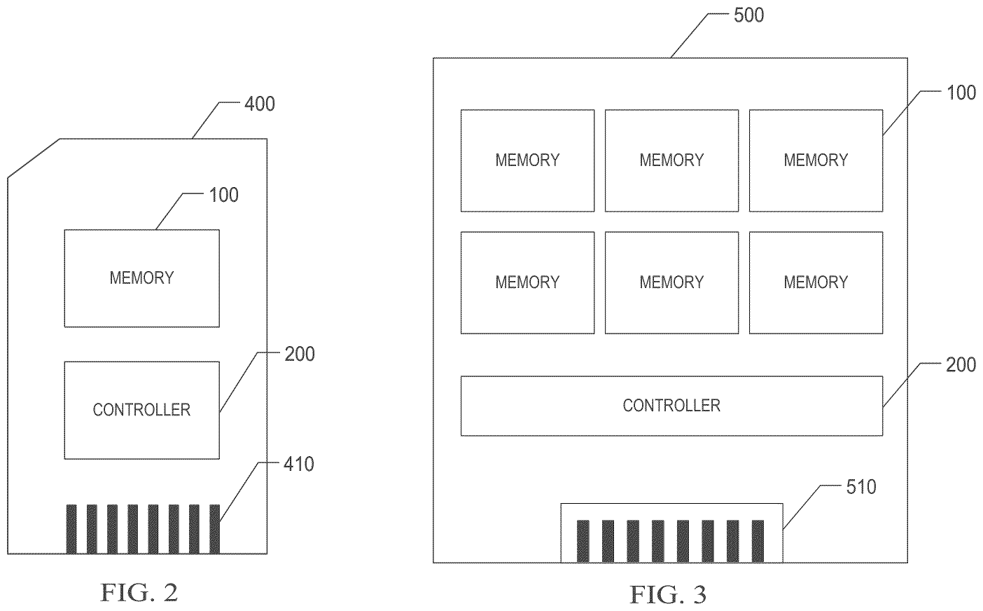

As an example, FIG. 2 is a schematic structural diagram of a memory card involved in the present application. As shown in FIG. 2, the controller 200 and a single memory 100 may be integrated into a memory card 400. The memory card 400 may include a personal computer memory card international association (PCMCIA, PC) card, a Compact Flash (CF) card, a Smart Media (SM) card, a memory stick, a Multi-Media Card (MMC), Reduced-Size MMC (RS-MMC), micro-MMC, Secure Digital (SD) card, Universal Flash Storage (UFS), etc. As shown in FIG. 2, the memory card 400 may further include a connector 410 that couples the memory card 400 with a host.

As another example, FIG. 3 is a schematic structural diagram of a solid-state drive involved in the present application. As shown in FIG. 3, the controller 200 and multiple memories 100 may be integrated into a Solid State Disk (SSD) 500. The solid state disk 500 may also include a connector 510 that couples the solid state disk 500 with a host. At least one of storage capacity or operation speed of the solid state disk 500 is greater than that of the memory card 400.

In addition, the memory 100 in FIG. 1 to FIG. 3 may be any memory involved in the examples of the present application, for example, it could be 3D NAND memory. The structure of the memory 100 is explained below.

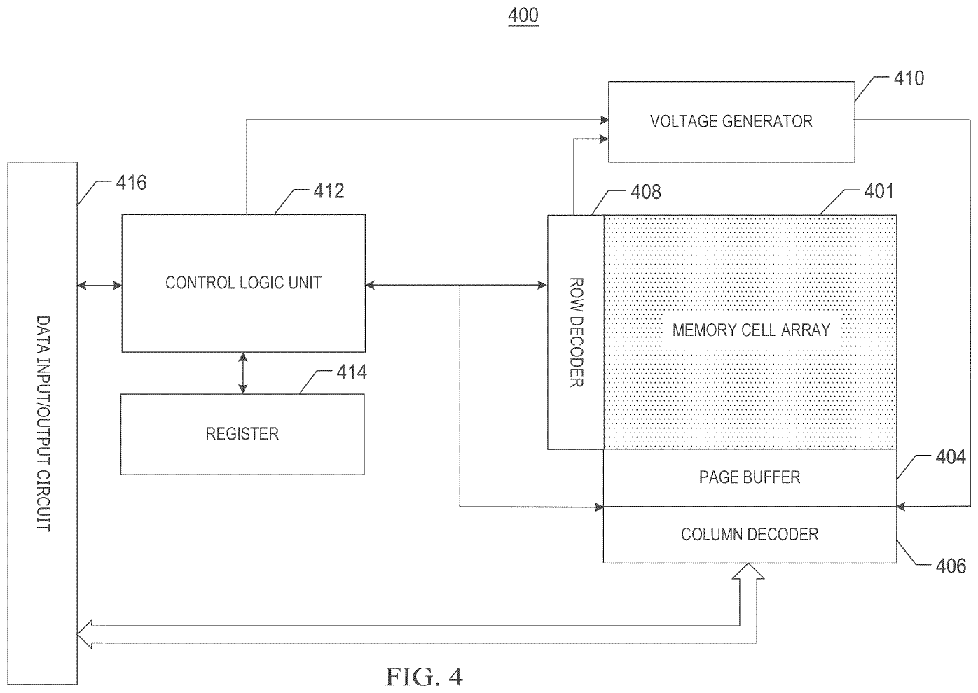

FIG. 4 is a block diagram of a memory according to an example of the present application. Referring to FIG. 4, the memory 400 may include a memory cell array 401, a page buffer 404, a column decoder 406, a row decoder (which may be referred to as a word line driver) 408, a voltage generator 410, a control logic unit 412, a register 414 and a data input/output circuit 416. Additional peripheral circuits not shown in FIG. 4 may also be included in some examples.

The page buffer 404 may be configured to read data from and program (write) data to the memory cell array 401 according to a control signal from the control logic unit 412. In one example, the page buffer 404 may store data (write data) to be programmed into a selected data during a program verification operation to ensure that the data has been correctly programmed into corresponding memory cells coupled to a selected word line of the memory cell array 401. The column decoder 406 can select one or more NAND memory strings in the memory cell array 401 in response to a control signal provided by the control logic unit 412. The row decoder 408 can operate in response to a control signal provided by the control logic unit 412, and select/deselect a selected row of the memory cell array 401. The row decoder 408 may also be configured to supply a voltage generated from the voltage generator 410 to the selected and unselected word lines of the memory cell array 401. As described in detail below, the row decoder/word line driver 408 is configured to perform erase operations on memory cells coupled to one or more selected word lines in the memory cell array 401. The voltage generator 410 may use an external power supply voltage or an internal power supply voltage to generate various voltages required by the memory 400, such as program voltages, read voltages, pass voltages, verification voltages, bit line voltages, etc., and combinations thereof.

The control logic unit 412 may be coupled to the voltage generator 410, the page buffer 404, the column decoder 406, the row decoder 408, the data input/output circuit 416, etc., and configured to control the operation of various peripheral circuits. The control logic unit 412 may generate operation signals in response to commands or control signals from the memory controller. The register 414 may be coupled to the control logic unit 412 and include a status register, a command register and an address register for storing status information, command operation codes (OP codes) and command addresses for controlling the operation of each peripheral circuit respectively. The data input/output circuit 416 may be coupled to the control logic unit 412 and act as a control buffer to buffer and relay control commands received from a host (not shown) to the control logic unit 412, and to buffer and relay status information received from the control logic unit 412 to the host. The data input/output circuit 416 may also be coupled to the column decoder 406 and act as a data input/output interface and a data buffer to buffer and relay data to or from the memory cell array 401.

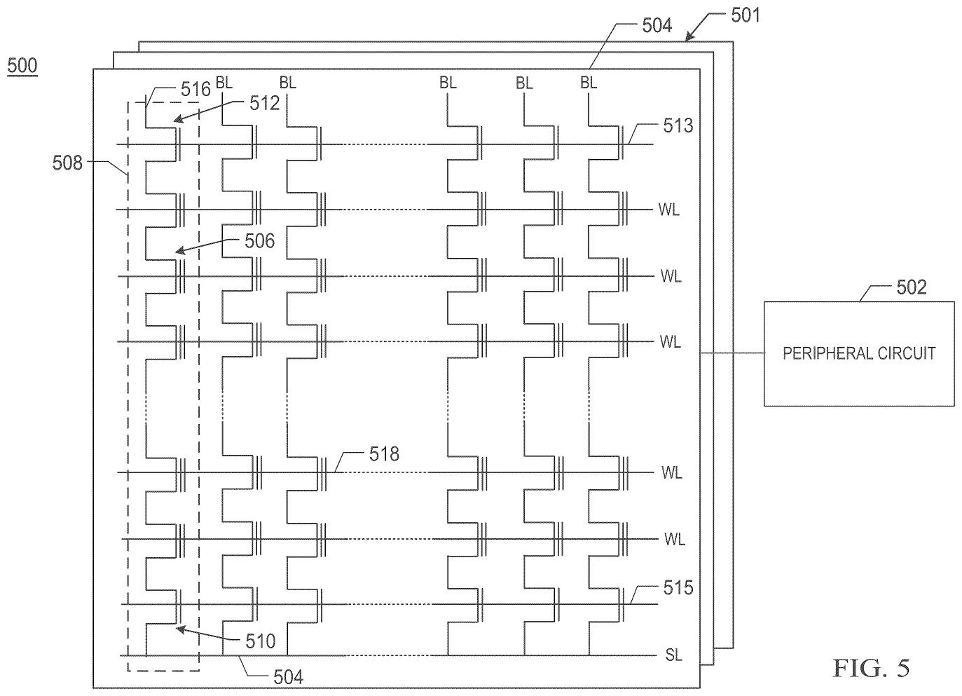

FIG. 5 is a schematic circuit diagram of a memory according to an example of the present application. As shown in FIG. 5, a memory 500 may include a memory cell array device 501 and a peripheral circuit 502 coupled to the memory cell array device 501. The memory cell array device 501 may be a NAND flash memory cell array in which memory cells 506 are provided in the form of an array of NAND memory strings 508 each extending vertically above a substrate (not shown). In some examples, each NAND memory string 508 includes a plurality of memory cells 506 coupled in series and stacked vertically. Each memory cell 506 can be either a floating gate type of memory cell including a floating-gate transistor or a charge trap type of memory cell including a charge trap transistor. In some implementations, each memory cell 506 is a single-level cell (SLC) that has two possible memory states and thus, can store one bit of data. For example, a first memory state “0” can correspond to a first range of voltages, and a second memory state “1” can correspond to a second range of voltages. In some implementations, each memory cell 506 is a multi-level cell that is capable of storing more than a single bit of data in more than two memory states, such as two bits per cell (MLC), three bits per cell (TLC), or four bits per cell (QLC).

As shown in FIG. 5, each NAND memory string 508 may include at least one source select transistor 510 at its source end and at least one drain select transistor 512 at its drain end. The source select transistor 510 and drain select transistor 512 may be configured to activate a selected NAND memory string 508 during read and program operations. In some implementations, the sources of NAND memory strings 508 in a same block 504 are coupled by a same source line (SL) 514. According to some implementations, the drain select transistor 512 of each NAND memory string 508 is coupled to a corresponding bit line 516. In some implementations, each NAND memory string 508 is configured to be selected or deselected by at least one of applying a select voltage or a deselect voltage (e.g., 0 V) to respective drain select transistor 512 through one or more drain select lines 516 or applying a select voltage or a deselect voltage (e.g., 0 V) to respective source select transistor 510 through one or more source select lines 515.

As shown in FIG. 5, a memory array unit may include multiple blocks. In some implementations, each block 504 is the basic data unit for an erase operation. For example, all memory cells 506 on the same block 504 are erased simultaneously.

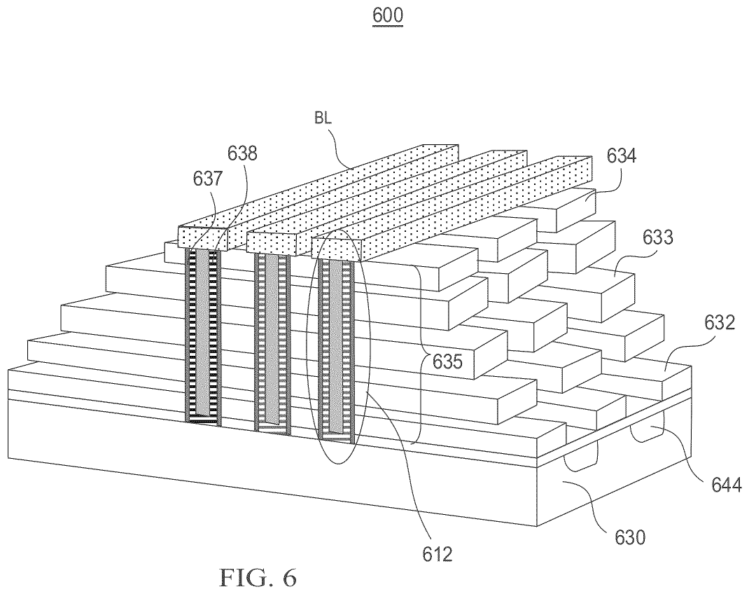

FIG. 6 is a perspective view of a part of a three-dimensional memory array structure shown in an example of the present application. The memory cell array structure 600 includes a substrate 630 and a stack structure above the substrate 630. The stack structure includes alternately stacked gate conductive layers and interlayer dielectric layers. The substrate 630 may include silicon (e.g., monocrystalline silicon), silicon germanium (SiGe), gallium arsenide (GaAs), germanium (Ge), silicon-on-insulator (SOI), germanium-on-insulator (GOI), or any other suitable materials. The gate conductive layer may include a conductive material including, but not limited to, tungsten (W), cobalt (Co), copper (Cu), aluminum (Al), polysilicon, doped silicon, silicide, or any combination thereof. In some implementations, each gate conductive layer 406 includes a metal layer, such as a tungsten layer. In some implementations, each gate conductive layer includes a doped polysilicon layer. The gate conductive layer may include a plurality of word lines 633, at least one source select line 632 and at least one drain select line 634.

As shown in FIG. 6, the memory cell array 600 includes a plurality of channel structures 612 extending vertically through a memory stack structure 635. In some examples, the channel structure 612 includes a memory film 637 and a channel 638. As shown in FIG. 6, according to some examples, a well 644 (e.g., at least one of a P-well or an N-well) is formed in the substrate 630, and the source terminals of the memory cell array are in contact with the well 644. It should be understood that although not shown in FIG. 6, additional components of the memory cell array 600 may be formed, including but not limited to gate line slits/source contacts, local contacts, interconnect layers, and the like.

Reference may be made to the descriptions of the computer system examples and method examples of the present application for the technical details not disclosed in the above memory-related hardware examples.

In the examples of the present application, data in a computer system can be divided into internal data and external data.

Internal data may be code and resource data of an operating system and application running in an electronic device where the computer system is located, as well as data generated during running of the operating system and application. For example, the data generated during running of the above operating system may include data such as running logs of the operating system, and the data generated during running of the above application may include cached data generated during running of the application (such as web page cache, chat record cache, etc.), file data downloaded from the network (such as downloaded audio and video, pictures, documents) and so on.

External data may be data copied by the user to memory of an electronic device from other devices other than the electronic device. For example, taking the electronic device being a mobile phone as an example, the external data can be file data copied from personal computer to the mobile phone by the user via a USB cable, such as various types of documents, pictures, videos, audios, etc. copied to the mobile phone.

In related technologies, when a user uses a mobile terminal as a mobile hard disk to store external data, the mobile terminal can be coupled to a personal computer via a Universal Serial Bus (USB) cable, and then the user can perform operation of copying data from the personal computer (that is, the external data of the mobile terminal) to memory space of the mobile terminal in an interface of a resource manager of the personal computer terminal. After that, a controller of a memory system of the mobile terminal writes the external data into a memory of the mobile terminal. However, the types of the external data and the internal data of the mobile terminal are different, and after the external data is written into the memory, the number of garbage collections in the memory system will increase and the lifetime of the memory will be affected.

In some examples, the memory systems in current electronic devices (mobile terminals such as mobile phones, tablet computers, etc.) do not distinguish between internal data and external data for the written data when writing the data. When users use the electronic devices to store external data (for example, copying a file from a personal computer to a mobile phone), a host in the computer system of the electronic device sends a write command to the controller to write the file data, and the controller instructs the memory to write the file data into this memory according to the write command.

Because a page is the basic data unit for program operations, when the memory is writing data, the smallest unit of its program operation is a page, which will cause the following situation: when the controller instructs the memory to write external data (such as the file data), if there is a writable page in a physical memory block (in some scenarios, it can also be referred to as a block, memory block or flash block, such as block 140 in FIG. 4), the file data may be written into the writable page in that physical memory block whether other pages in the physical memory block have stored internal data. For example, a physical memory block may store external data in some pages, and store internal data in some other pages.

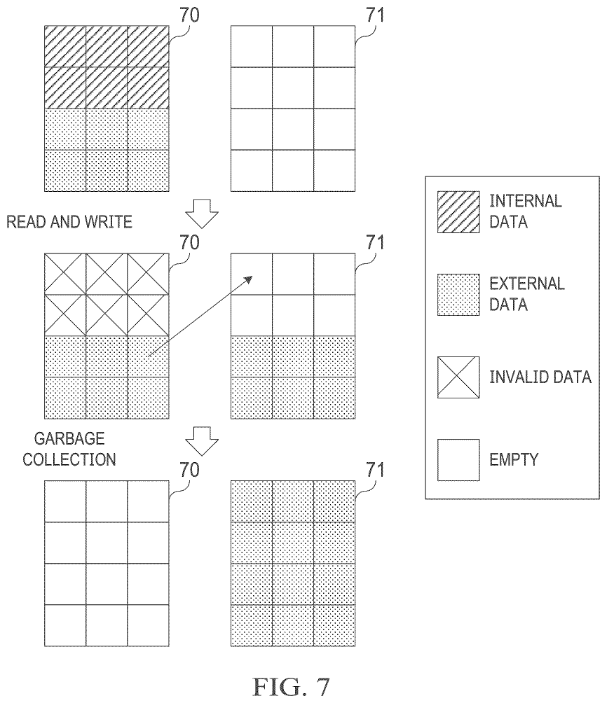

For example, referring to FIG. 7, a schematic diagram of data storage on a physical memory block involved in the present application is shown. As shown in FIG. 7, assuming that the physical memory block 70 in the memory corresponds to 12 pages, when external data is written to the memory, it might be a situation in which 6 pages in the physical memory block 70 store internal data, and the other 6 pages store external data. The internal data may be hot data, which will be frequently accessed by the host, while the external data is not frequently accessed. For the physical memory block 70 shown in FIG. 7, in which the internal data in 6 pages may become invalid data after a period of time, while the external data of the other 6 pages will continue to be valid data. At this time, if the memory system triggers a garbage collection operation, a garbage collection operation will be performed on the physical memory block 70. For example, the external data of the other 6 pages in the physical memory block 70 is transferred to another physical memory block 71 so that the physical memory block 70 can be erased. At this time, other pages other than the pages storing the external data in the physical memory block 71 might also have internal data stored thereon. Alternatively, other pages other than the pages storing the external data in the physical memory block 71 might also have internal data newly written thereto. In this way, the garbage collection operation might need to be performed again on the physical memory block 71 after a period of time.

With reference to FIG. 7, it can be seen that in a case of storing external data in the memory system, the physical memory blocks storing external data will be frequently garbage collected due to the difference in the frequency of access between external data and internal data, affecting the lifetime of physical memory blocks.

In this regard, the solution shown in the subsequent examples of the present application differentiates the writing of external data and internal data, for example, writes external data and internal data into different physical memory blocks during the data writing.

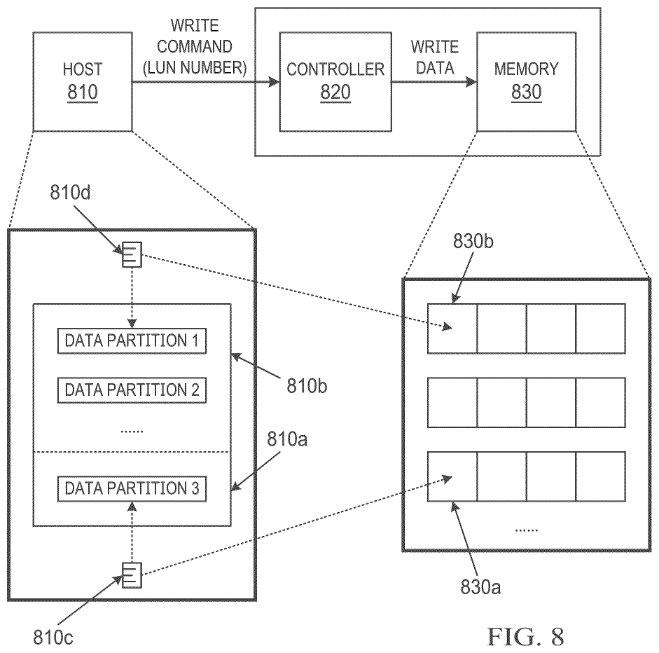

Referring to FIG. 8, a frame diagram of a computer system according to an example of the present application is shown. The computer system may be the system 10 shown in FIG. 1. As shown in FIG. 8, the computer system includes a host 810, a controller 820 and a memory 830.

The memory space of the memory 830 is divided into at least two types of data partitions. The at least two types include a first type corresponding to external data of an electronic device including the computer system, and a second type corresponding to internal data of the electronic device.

The memory space of the above-mentioned memory 830 is divided into at least two types of data partitions. It is understood that the memory space of the memory 830 is a logical memory space, and the memory space is divided into at least two types of logical data partitions.

Alternatively, the memory space of the above-mentioned memory 830 is divided into at least two types of data partitions. It is also understood that the memory space of the memory 830 is a physical memory space, and the logical space corresponding to the memory space is divided into at least two types of logical data partitions.

In addition, the at least two types of data partitions include a first type and a second type, wherein the first type corresponds to external data, and the second type corresponds to internal data.

Each type of data partition may include one or more data partitions. The example of the present application does not limit the number and capacity of each type of data partition.

For example, as shown in FIG. 8, on the host 810 side, the memory space of the memory 830 is divided into a first type of data partition 810a corresponding to external data, and a second type of data partition 810b corresponding to internal data. The first type of data partition 810a shown in FIG. 8 includes one data partition (data partition 3), and the second type of data partition 810b includes two data partitions (data partition 1 and data partition 2). In some examples, the first type of data partition 810a may also include more data partitions. Correspondingly, the second type of data partition 810b may include only one data partition, or may include three or more data partitions.

The host 810 is configured to send a write command to the controller 820. The write command includes first data to be written into the memory and a logical unit number into which the first data is to be written, wherein the logical unit number is specified according to the type of data partition. The controller 820 is configured to instruct the memory 830 to write the first data into a physical memory block corresponding to the logical unit number in the memory according to the logical unit number. A physical memory block corresponding to the first type of data partition is different from a physical memory block corresponding to the second type of data partition.

When the above-mentioned host 810 needs to write the first data, it can specify in the write command the Logical Unit Number (LUN) into which the first data is to be written, wherein the logical unit number is associated with the type of data partition corresponding to the first data.

In some examples, when the first data is external data, the LUN number in the write command is specified by the first type, and the first data will be written into the physical memory block corresponding to the first type of data partition. When the first data is internal data, the LUN number in the write command is specified by the second type, and the first data will be written into the physical memory block corresponding to the second type of data partition.

Different logical unit numbers may correspond to different physical memory blocks, and the logical unit number corresponding to the first type of data partition may also be different from the logical unit number corresponding to the second type of data partition. At this time, in the above computer system, the data of the first type of data partition (external data) will be written into the physical memory block corresponding to the external data, while the data of the second type of data partition (internal data) will be written into the physical memory block corresponding to the internal data. The physical memory blocks into which the internal data and external data are written are different. For example, in the above computer system, internal data and external data will not be stored in one physical memory block at the same time.

For example, as shown in FIG. 8, the file 810c is external data, and the file 810d is internal data. When the host 810 writes the data in the file 810c, the LUN number in the write command is specified by the first type. At this time, the controller 820 instructs the memory 830 to write the data into the physical memory block 830a corresponding to the first type of data partition. When the host 810 writes the data in the file 810d, the LUN number in the write command is specified by the second type. At this time, the controller 820 instructs the memory 830 to write the data into the physical memory block 830b corresponding to the second type of data partition. The physical memory block 830a and the physical memory block 830b are different physical memory blocks.

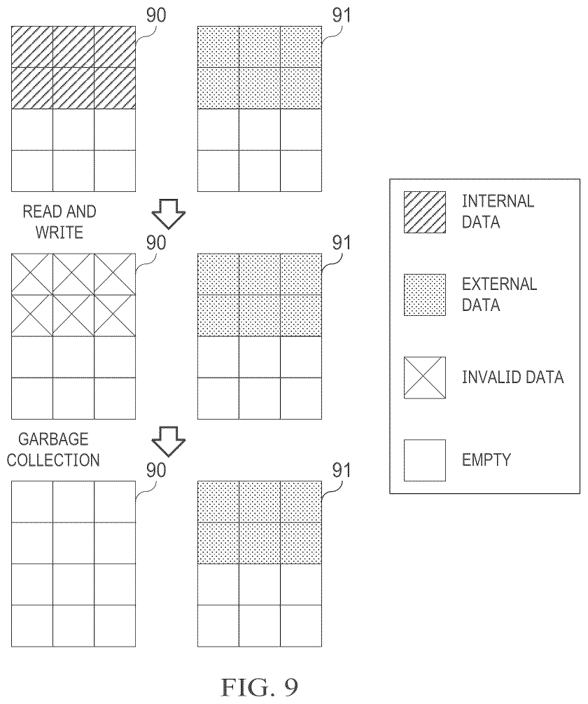

For example, referring to FIG. 9, a schematic diagram illustrating data storage on a physical memory block involved in the present application is shown. As shown in FIG. 9, it is assumed that the physical memory block 90 and the physical memory block 91 in the memory of the computer system involved in the example of the present application correspond to 12 pages respectively, wherein the physical memory block 90 is the physical memory block corresponding to the first type of data partition, and the physical memory block 91 is a physical memory block corresponding to the second type of data partition.

As shown in FIG. 9, when the host writes external data to the memory, the LUN in the write command is specified by the first type and corresponds to the LUN of the physical memory block 90, and the controller instructs the memory to write the external data into 6 pages in the physical memory block 90. Correspondingly, when the host writes internal data to the memory, the LUN in the write command is specified by the second type and corresponds to the LUN of the physical memory block 91, and the controller instructs the memory to write the internal data into 6 pages in the physical memory block 91. After a period of time, the external data in the physical memory block 90 is still valid data without being read, and the external data in the physical memory block 91 becomes invalid data after being read. At this time, the memory system will perform garbage collection on the physical memory block 91 and will not perform garbage collection on the physical memory block 90.

Combining with reference to FIG. 9, it can be seen that in the case of storing external data in the memory system, the garbage collection performed on the physical memory block where the internal data is located will not affect the physical memory block where the external data is located since the external data and internal data are written into different physical memory blocks, which can reduce the number of garbage collections of the physical memory block storing external data, and increase the lifetime of the corresponding physical memory block.

To sum up, in a computer system involved in the present application comprising a host, a controller and a memory, memory space of the memory is divided into different data partitions according to a data type (for example, external data and internal data of an electronic device), and different types of data partitions correspond to different physical memory blocks in the memory. When the host sends a write command to the controller, a logical unit number in the write command is specified by the type of the data partition, and the controller instructs the memory to write first data into a physical memory block corresponding to the logical unit number in the memory. With the above processing, the external data and internal data can be written into different physical memory blocks in the memory. A garbage collection operation is performed in units of physical memory blocks, that is, read and write operations on the internal data will not affect the physical memory block where the external data is located. Because the external data will not be read and written frequently with respect to the internal data, garbage collection operations are rarely carried out on the physical memory block written with external data in the memory. Therefore, in the case of storing external data in the memory system, the number of garbage collections on the physical memory block storing external data in the memory system can be reduced, and the lifetime of the memory can be improved, according to the above technical solution.

Based on the computer system in the example shown in FIG. 8, in an example, the controller 820 may be configured to determine the physical memory block corresponding to the logical unit number according to the logical unit number, and instruct the memory 830 to write the first data into the physical memory block corresponding to the logical unit number.

In the above example, the controller 820 can determine the physical memory block corresponding to the LUN carried by the write command from individual physical memory blocks in the memory 830. Since the logical unit number is specified according to the type of the data partition, and it is needed to ensure that the physical memory block corresponding to the first type of data partition is different from the physical memory block corresponding to the second type of data partition. Therefore, the physical memory blocks corresponding to the logical unit number determined by the controller 820 are different physical memory blocks for external data and internal data.

The above-mentioned physical memory block corresponding to the logical unit number may refer to one or more physical memory blocks among the individual physical memory blocks into which data in the type of the data partition corresponding to the logical unit number is allowed to be written.

For example, when the above-mentioned first data is external data, the above-mentioned physical memory block corresponding to the logical unit number is one or more physical memory blocks among the physical memory blocks into which the first data is allowed to be written.

As another example, when the above-mentioned first data is internal data, the above-mentioned physical memory block corresponding to the logical unit number is one or more physical memory blocks among the physical memory blocks into which second data is allowed to be written.

The above-mentioned individual physical memory blocks into which data in the type of the data partition corresponding to the logical unit number is allowed to be written may refer to physical memory blocks that have a fixed association relationship with the logical unit number. In an example, when the above-mentioned controller 820 determines the physical memory block corresponding to the logical unit number according to the logical unit number, the physical memory block corresponding to the logical unit number may be determined according to the association relationship between the logical unit number and the physical memory block.

In an example, when the controller 820 determines the physical memory block corresponding to the logical unit number according to the logical unit number, individual physical memory blocks associated with the logical unit number might be firstly determined, and then one or more physical memory blocks that are not fully written can be determined from the individual physical memory blocks associated with the logical unit number as the above-mentioned physical memory block corresponding to the logical unit number.

In an example, the above-mentioned association relationship between the logical unit number and individual physical memory blocks may be an association relationship between a complete logical unit number and individual physical memory blocks.

In some other examples, the above-mentioned association relationship between the logical unit number and individual physical memory blocks may be an association relationship between one or more bits in the logical unit number and individual physical memory blocks. For example, if the logical unit number is 8-bit data, one or more bits (such as the highest bit or the second highest bit) are to indicate the type of the data partition corresponding to the logical unit number. For example, “1” indicates that the type of the data partition corresponding to this logical unit number is the first type (corresponding to external data), “O” indicates that the type of the data partition corresponding to this logical unit number is the second type (corresponding to internal data), and the controller 820 can determine individual physical memory blocks associated with the logic unit number according to the value of this bit. In turn, one or more physical memory blocks that are not fully written can be determined from the individual physical memory blocks associated with this logical unit number as the physical memory block corresponding to this logical unit number.

In an example, the association relationship between the logical unit number and individual physical memory blocks may be pre-stored in the cache of the controller 820 or in the memory 830, and the association relationship may be stored in the form of a relationship table or a relationship item. For example, the association relationship between the above-mentioned logical unit number and individual physical memory blocks may be set when the memory space of the memory 830 is configured as the at least two types of data partitions in the host. For example, the memory space of the memory 830 can be configured as the at least two types of data partitions in the host during system setting of an electronic device before leaving the factory, and the logical unit numbers corresponding to each type of data partition can be divided. At the same time, the association relationship between the above-mentioned logical unit numbers and individual physical memory blocks in the memory 830 can be configured. Alternatively, during initial startup of an operating system of the electronic device/restoring the factory settings by the user, the host guides the user to configure a part of the memory space in the memory 830 of the electronic device as the external data memory space, and after the user configures the external data memory space, the host configures the memory space of the memory 830 as at least two types of data partitions, and divides the logical unit numbers corresponding to each type of data partition. At the same time, the controller 820 configures the association relationship between the above-mentioned logical unit number and individual physical memory blocks in the memory 830.

In some other examples, the above-mentioned association relationship between the logical unit number and individual physical memory blocks may also be pre-defined in firmware. For example, the above-mentioned association relationship between the logical unit number and individual physical memory blocks may be predefined by a protocol.

In some other examples, the above-mentioned association relationship between the logical unit number and the physical memory blocks may also be an implicit association relationship. For example, the above-mentioned controller 820 is configured to: obtain data attribute of the first data according to the logical unit number, wherein the data attribute is configured to indicate whether the first data is the external data of the electronic device or the internal data of the electronic device, determine the physical memory block corresponding to the logical unit number in the memory according to the data attribute, and instruct the memory 830 to write the first data into the physical memory block corresponding to the logical unit number.

In the above example, the correspondence between the logical unit number and the data attribute may be pre-stored in the cache of the controller 820 or the memory 830, or the correspondence between the logical unit number and the data attribute may be pre-defined by the firmware of the controller 820. After receiving the write command, the controller 820 can determine the data attribute of the first data according to the logical unit number in the write command, for example, determine whether the first data is external data or internal data. Then, the physical memory block corresponding to the logical unit number is determined in the memory according to the data attribute.

In an example, the controller 820 is configured to: in a case where the data attribute is configured to indicate that the first data is the external data of the electronic device, determine at least one physical memory block satisfying a first condition in the memory as the physical memory block corresponding the logic unit number, the first condition comprising: the physical memory block is not full, and second data is not stored, wherein the second data is data in the second type of data partition. For example, the controller 820 determines at least one physical memory block that is not full from other memory blocks other than the physical memory block where the data in the second type of data partition is located, as the physical memory block corresponding to the logical unit number. The controller 820 is configured to: in a case where the data attribute is configured to indicate that the first data is the internal data of the electronic device, determine at least one physical memory block satisfying a second condition in the memory as the physical memory block corresponding the logic unit number, the second condition comprising: the physical memory block is not full, and third data is not stored, wherein the third data is data in the first type of data partition. For example, the controller 820 determines at least one physical memory block that is not full from other memory blocks other than the physical memory block where the data in the first type of data partition is located, as the physical memory block corresponding to the logical unit number.

In the above example, when the first data is external data, the physical memory block corresponding to the logical unit number determined by the controller 820 will not have internal data stored thereon. Similarly, when the first data is internal data, the physical memory block corresponding to the logical unit number determined by the controller 820 will not have external data stored thereon, so that it is ensured that the physical memory blocks where the external data is located are isolated from the physical memory blocks where the internal data is located in the memory during the writing of data.

In an example, a correspondence between the type of the data partition and a physical memory block where data in the data partition is located is a non-fixed configuration relationship. The controller 820 is configured to: in the case where the data attribute is configured to indicate that the first data is the external data of the electronic device, determine at least one physical memory block satisfying the first condition from all writable physical memory blocks of the memory as the physical memory block corresponding to the logical unit number. In the case where the data attribute is configured to indicate that the first data is the internal data of the electronic device, determine at least one physical memory block satisfying the second condition from all writable physical memory blocks of the memory as the physical memory block corresponding to the logical unit number.

The above-mentioned correspondence between the type of the data partition and a physical memory block where data in the data partition is located is a non-fixed configuration relationship which means that whether external data or internal data is written to the memory, it may be written into any physical memory block in the memory, as long as the external data and the internal data do not exist on the same physical memory block at the same time. For example, after the data partition is set, the logically expressed data partition does not fixedly correspond to certain physical memory blocks. When data is written, and after the controller 820 allocates corresponding physical memory blocks for the data to be written, these allocated physical memory blocks could correspond to the data partition where the data is located.

Correspondingly, when the controller 820 instructs the memory 830 to write the first data, it can search all available physical memory blocks in the memory 830 for a physical memory block that satisfies the condition that the external data and the internal data do not exist on the same physical memory block at the same time and that is not currently full (including the physical memory block whose all pages or some pages are empty) in combination with the data attribute of the first data. In some examples, when the data attribute of the first data indicates that it is external data, the controller 820 determines one or more physical memory blocks that are not currently full and do not have internal data from all available physical memory blocks in the memory 830, and instructs the memory 830 to write the first data into the one or more physical memory blocks. Alternatively, when the data attribute of the first data indicates that it is internal data, the controller 820 determines one or more physical memory blocks that are not currently full and do not have external data from all available physical memory blocks in the memory 830, and instructs the memory 830 to write the first data into the one or more physical memory blocks.

With the above scheme, for a certain physical memory block in the memory, one type of data among the external data or internal data can be written into the physical memory block at a certain moment. After a period of reading and writing and garbage collection, another type of data among the external data or internal data can be written into the physical memory block at another subsequent moment, as long as only one of the external data or internal data is stored in the physical memory block at the same moment.

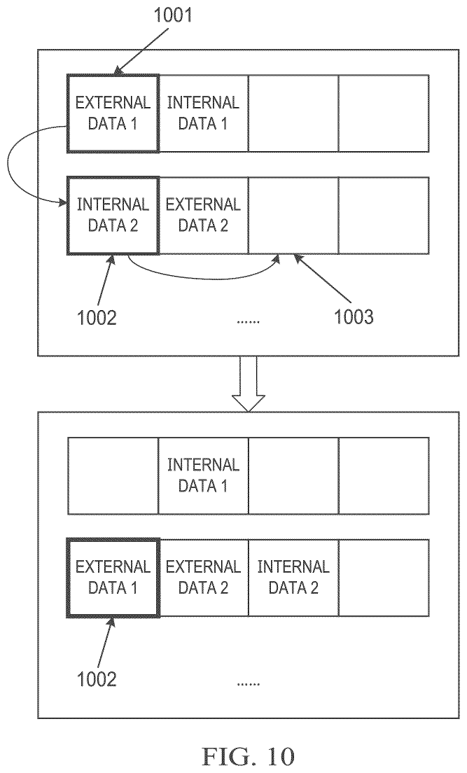

For example, referring to FIG. 10, a schematic diagram illustrating data storage location change involved in this application is shown. As shown in FIG. 10, at time 1, external data 1 is stored in a physical memory block 1001, internal data 2 is stored in a physical memory block 1002. During the subsequent read and write, the internal data 2 is written into a physical memory block 1003, and the physical memory block 1002 is collected. At this time, the physical memory block 1002 is an empty physical memory block. At a subsequent time 2, the external data 1 in the physical memory block 1001 can be written into the physical memory block 1002.

As can be seen from FIG. 10 above, each physical memory block in the memory can be used to store different types of data at different times, thereby ensuring the flexibility of storing different types of data in the physical memory block, and thus ensuring the utilization rate of the physical memory blocks.

In an example, a correspondence between the type of the data partition and a physical memory block where data in the data partition is located is a fixed configuration relationship. The controller 820 is configured to: in the case where the data attribute is configured to indicate that the first data is the external data of the electronic device, determine at least one physical memory block that is not full from individual physical memory blocks preconfigured for the first type of data partition as the physical memory block corresponding to the logical unit number; and in the case where the data attribute is configured to indicate that the first data is the internal data of the electronic device, determine at least one physical memory block that is not full from individual physical memory blocks pre-configured for the second type of data partition as the physical memory block corresponding to the logical unit number.

The above-mentioned correspondence between the type of the data partition and a physical memory block where data in the data partition is located is a fixed configuration relationship means that for a physical memory block, the data written into that physical memory block at different times is the same type of data among the external data and internal data. For example, at different times, that physical memory block will only be written with external data or internal data. For example, a part of the physical memory block in the memory has been pre-allocated for external data, another part of the physical memory block has been pre-allocated for internal data, and there is no overlap between the two parts of the physical memory block. Correspondingly, when the controller 820 instructs the memory 830 to write the first data, it can search a part of the physical memory blocks corresponding to the data attribute in the memory 830 for the physical memory block that is currently not full (including the physical memory block where all pages or some pages are empty) in combination with the data attribute of the first data. In some examples, when the data attribute of the first data indicates that it is external data, the controller 820 determines one or more physical memory blocks that are not currently full from the physical memory blocks that are pre-allocated for external data in the memory 830, and instructs the memory 830 to write the first data into the one or more physical memory blocks. Alternatively, when the data attribute of the first data indicates that it is internal data, the controller 820 determines one or more physical memory blocks that are not currently full from the physical memory blocks that are pre-allocated for internal data in the memory 830, and instructs the memory 830 to write the first data into the one or more physical memory blocks.

With the above scheme, for a certain physical memory block, one type of data among the external data and internal data can be written into that physical memory block at a certain moment. At subsequent another moment after a period of reading and writing and garbage collection, the same type of data can be written into the physical memory block, and another type of data among the external data and internal data will not be written into the physical memory block. For example, at different moments, only one type of data among external data and internal data is stored in the physical memory block.

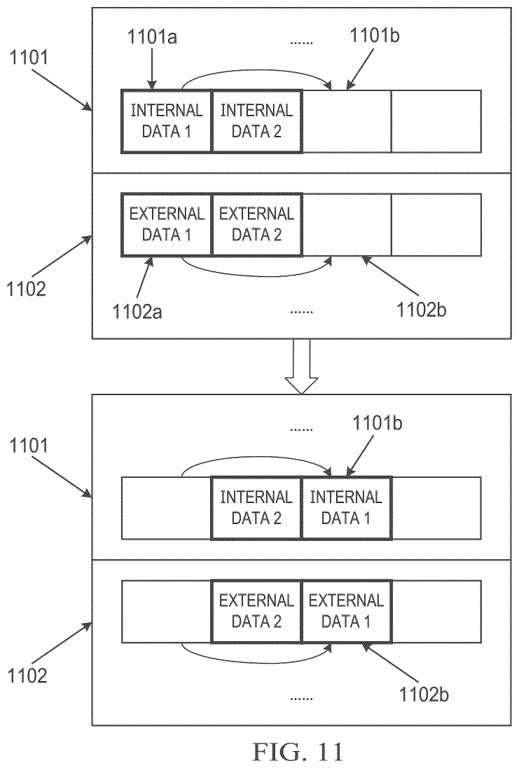

For example, referring to FIG. 11, another schematic diagram illustrating data storage location change involved in this application is shown. As shown in FIG. 11, the physical memory blocks in the memory are divided into a block group 1101 and a block group 1102, wherein internal data is stored in each physical memory block in the block group 1101, and external data is stored in each physical memory block in the block group 1102. In FIG. 11, at the initial moment, internal data 1 is stored in a physical memory block 1101a in the block group 1101, and external data 1 is stored in a physical memory block 1102a in the block group 1102. In the subsequent read and write process, the controller can instruct the memory to write the internal data 1 into a physical memory block 1101b in the same block group during reading and writing of the internal data 1, and the controller can instruct the memory to write the external data 1 into a physical memory block 1102b in the same block group during reading and writing of the external data 1. For example, the internal data will not be written into the block group 1102, and similarly, the external data will not be written into the block group 1101 either.

It can be seen from FIG. 11 above that, for data corresponding to a certain data attribute, when the controller 820 determines the writable physical memory block, it only needs to search a part of the physical memory blocks corresponding to the data attribute for the physical memory block that is not full, and it is not needed to search from the entire memory 830, thereby ensuring the efficiency of data writing.

In an example, the correspondence between the logical unit number and the data attribute of the first data is predefined by a protocol. At this time, the correspondence between the logical unit number and the data attribute of the first data can be pre-defined in firmware.

Alternatively, the above-mentioned correspondence between the logical unit number and the data attribute of the first data is set when the memory space of the memory is configured as the at least two types of data partitions in the host. For example, the memory space of the memory 830 is configured as the at least two types of data partitions in the host during system setting of an electronic device before leaving the factory, and the logical unit numbers corresponding to each type of data partition is divided. At the same time, the correspondence between the above-mentioned logical unit numbers and the data attribute is configured. Alternatively, during initial startup of an operating system of the electronic device/restoring the factory settings by the user, the host guides the user to configure a part of the memory space in the memory 830 of the electronic device as the external data memory space, and after the user configures the external data memory space, the host configures the memory space of the memory 830 as at least two types of data partitions, and divides the logical unit numbers corresponding to each type of data partition. At the same time, the controller 820 configures the association relationship between the above-mentioned correspondence between the logical unit number and the data attribute.

Based on the computer system in the example shown in FIG. 8, in an example, when writing the first data, the impact of external data or internal data on the management of the physical memory block where it is located may also be considered.

In an example, the controller 820 is further configured to set a data type of the first data according to the type of the data partition into which the first data is written, and wherein the data type is to manage the first data or the physical memory block where the first data is located.

In the example of the present application, the controller 820 can set the corresponding data type for the first data according to the type of the data partition into which the first data is written. For data of different data types, the physical memory block where the data is located can be subsequently managed in different management manners.

For example, when the type of the data partition into which the first data is written is the first type, the controller 820 may set the data type of the first data as the first data type. When the physical memory block where the first data is located is subsequently managed, a longer time interval can be used to detect whether this physical memory block needs to be garbage collected or wear leveled.

As another example, when the type of the data partition into which the first data is written is the second type, the controller 820 may set the data type of the first data as the second data type. When the physical memory block where the first data is located is subsequently managed, a shorter time interval can be used to detect whether this physical memory block needs to be garbage collected or wear leveled.

In an example, the above-mentioned data types may include: cold data or hot data.

In the example of the present application, the controller 820 can set the data type of the first data as one of cold data or hot data according to the type of the data partition into which the first data is written, so as to utilize the data type of the existing cold data/hot data, which simplifies the setting logic of the data type.

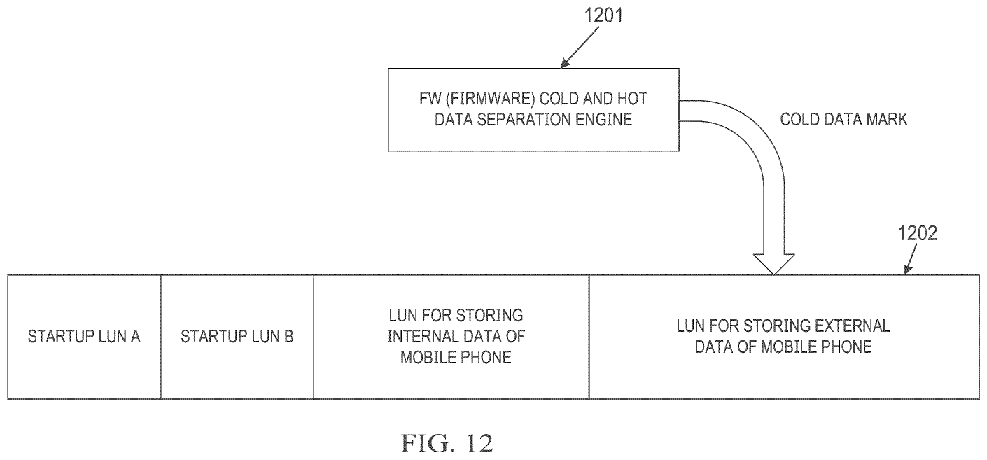

For example, referring to FIG. 12, a schematic diagram illustrating writing setting of external data involved in the present application is shown. As shown in FIG. 12, the firmware in the controller is provided with a hot and cold data separation engine 1201, and the memory space of the memory in the mobile phone is divided into four data partitions corresponding to four groups of LUNs, including two groups of LUNs for system startup, a group of LUNs for storing internal data of the mobile phone, and a group of LUNs 1202 for the user storing external data of the mobile phone. The data written into the LUN 1202 will be marked as cold data by the hot and cold data separation engine 1201. At the same time, the physical memory block where the data in the data partition corresponding to the LUN 1202 is located is different from the physical memory block where the data in the data partition corresponding to other LUNs is located, thereby reducing garbage collection and obtaining better write amplification performance.

In some other examples, the above-mentioned data types may also be newly added, and are used for differentiated management of internal data or external data.

Based on the computer system in the example shown in FIG. 8, in an example, the first type of data partition corresponding to external data, as a logical data partition, can be unloaded or loaded in an interface of a resource manager of the host, so as to achieve the effect of hiding or displaying the memory space used for external data in the electronic device.

In an example, the host 810 is further configured to: in a case where the first type of data partition has been loaded, display an unload control on an interactive interface; and in a case where a trigger operation on the unload control is received, unload the first type of data partition in an interface of a resource manager of the host.

In the example of the present application, in the interactive interface displayed to the user on the host side, the data partition/entrance of the data partition divided from the memory space of the above-mentioned memory 830 can be displayed. By triggering (such as clicking) the data partition/entrance of the data partition, the data stored in that data partition can be viewed, and interactive operations may be performed on the data stored in that data partition, such as opening, copying, deleting, cutting, sending, and so on.

For example, in an application scenario, for the more important data of the internal data of the electronic device, the user can back up the data to the data partition for the external data. For example, the user can view the data to be backed up (such as a photo) in the data partition corresponding to the internal data, long press the photo, select “copy” in a pop-up selection box, and then enter the data partition for external data, long press the blank area and select “paste” in the pop-up selection box, so that the photo is backed up to the data partition for external data. The photo copied to the data partition for external data will be stored as external data, which is equivalent to the process of writing the photo as external data into the first type of data partition.

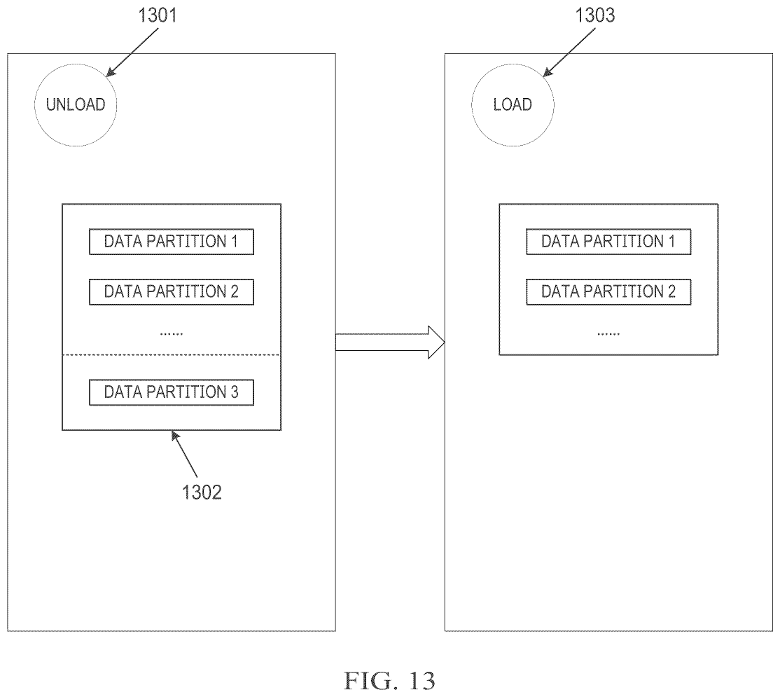

The data partition for the external data may be unloaded in the interface of the resource manager of the host, so that the data partition/entrance of the data partition for the external data is hidden. For example, referring to FIG. 13, a schematic diagram illustrating data partition unloading of external data involved in this application. Taking the interactive interface being the same as the interface of resource manager as an example, as shown in FIG. 13, an unload control 1301, a data partition 1302 for external data, and data partitions for internal data are displayed in the interface of the resource manager of the host. After the user clicks the unload control 1301, the data partition 1302 for the external data is hidden. The above process can be referred to as unloading the data partition for the external data.

In an example, authentication logic may be added to the process of unloading the data partition for the external data, that is, to verify whether the user has the permission to unload the data partition for the external data in the interface of the resource manager of the host. For example, in a case where a trigger operation on the unload control is received, the host 810 can display an authentication interface on the interactive interface, prompting the user to input authentication information, such as a password. After the user enters the password, the host 810 matches the password entered by the user with a preset password, and if the matching is successful, the first type of data partition is unloaded in the interface of the resource manager of the host.

The above-mentioned unloading process of the first type of data partition does not affect the isolation of physical memory blocks for external data and internal data in the memory. In some examples, after the above-mentioned first type of data partition is unloaded, when the host 810 writes data into the data partition for the internal data subsequently, the logical unit number carried in the write command sent to the controller 820 is still specified by the type of the data partition for the internal data. Correspondingly, the controller 820 instructs the memory 830 to write the data into the physical memory block corresponding to the logical unit number according to the logical unit number, so that the data and the existing external data in the memory are isolated at the level of physical memory block.

In an example, the host is further configured to: in a case where the first type of data partition has not been loaded, display a load control on an interactive interface; and in a case where a trigger operation on the load control is received, load the first type of data partition in an interface of a resource manager of the host.

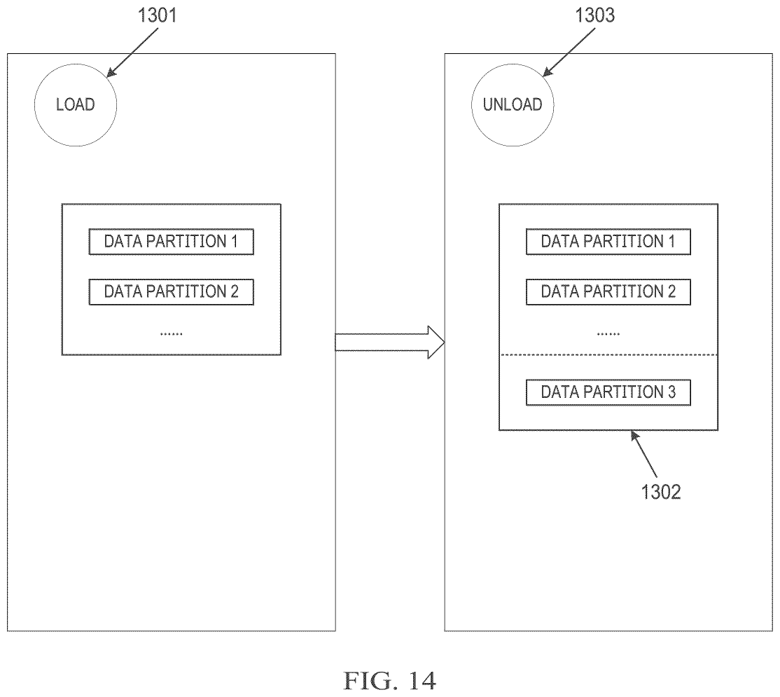

The unloaded data partition for the external data may also be reloaded in the interface of the resource manager of the host, so that the data partition/entrance of the data partition for the external data is displayed again. For example, referring to FIG. 14 in combination with FIG. 13, a schematic diagram illustrating loading data partition for external data involved in this application is shown. In FIG. 13, the user clicks the unload control 1301, and after the data partition 1302 for the external data is hidden, the unload control 1301 in the interface of resource manager is replaced with a load control 1303. In FIG. 14, after the user clicks the load control 1303, the data partition 1302 for the external data is displayed again. The above process may be referred to as loading the data partition for the external data.

In an example, authentication logic may be added to the loading process of the data partition for the external data, that is, to verify whether the user has the permission to load the data partition for the external data in the interface of the resource manager of the host. For example, in a case where a trigger operation on the load control is received, the host 810 can display an authentication interface on the interactive interface, prompting the user to input authentication information, such as a password. After the user enters the password, the host 810 matches the password entered by the user with a preset password, and if the matching is successful, the first type of data partition is loaded in the interface of the resource manager of the host.

Based on the computer system in the example shown in FIG. 8, in an example, the first type of data partition corresponding to external data, as a logical data partition, can also be visible for other external devices other than electronic devices so that the effect of directly writing data into the memory space for external data in the electronic device in the external device is achieved.

In an example, the host 810 is further configured to: in response to the electronic device being coupled to an external device via a Universal Serial Bus interface, display a trigger control corresponding to the first type of data partition on an interactive interface; and in a case where a selection operation on the trigger control is received, allow the first type of data partition to be accessed at the external device side.

For example, the electronic device can be coupled to the external device via a USB cable. At this time, the first type of data partition/interface of the data partition can be displayed in the resource manager of the external device. At this time, on the external device side, the user may view the data stored in that data partition by triggering (for example, clicking) that data partition/entrance of the data partition, and perform interactive operations on the data stored in that data partition.

For example, in an application scenario, for the data that needs to be backed up or copied in the external device, the user can store that data into the data partition for the external data of the electronic device. For example, the user can view the data to be copied (such as a certain photo) in the external device, long press the photo, select “copy” in the pop-up selection box, and then enter the data partition for external data of the electronic device displayed on the external device side, long press the blank area and select “paste” in the pop-up selection box, so as to write the photo into the data partition for the external data of the electronic device. The photo copied to the data partition for the external data will be stored as the external data by the host 810 of the electronic device.

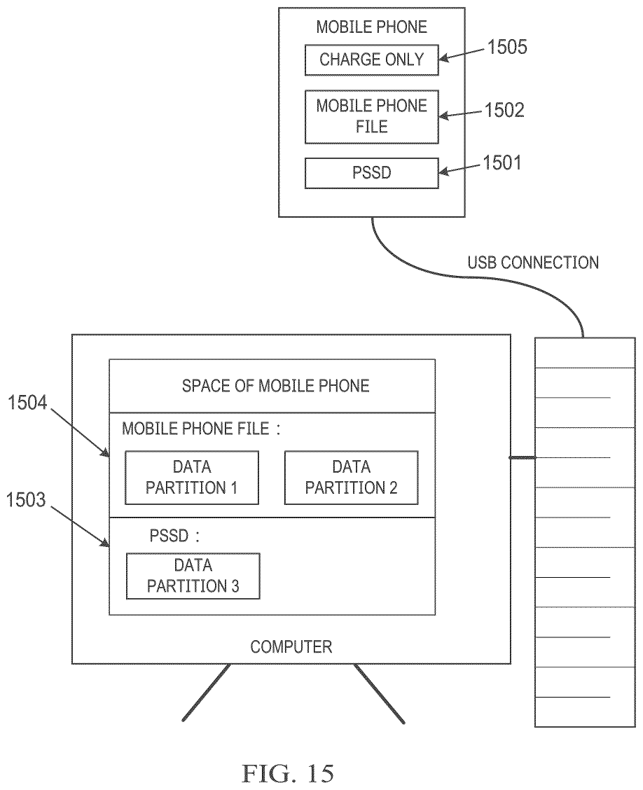

When the electronic device is coupled to the external device, the data partition for the external data may be selected to be displayed or hidden in the interface of the resource manager at the external device side in the interactive interface of the host. For example, referring to FIG. 15, a schematic diagram illustrating device connections involved in this application is shown. Taking the electronic device being a mobile phone and the external device being a personal computer as an example, as shown in FIG. 15, when the mobile phone is connected (coupled) to the computer via a USB cable, three options are popped up on the mobile phone interface, namely option 1501, option 1502 and option 1505. When the user selects the option 1501, the interface of the resource manager of the computer displays a Portable Solid State Drives (PSSD) partition 1503 and a mobile phone file partition 1504, wherein the PSSD partition 1503 corresponds to the first type of data partition for storing external data in the mobile phone, the mobile phone file partition 1504 corresponds to the second type of data partition for storing internal data in the mobile phone, and at the same time, the computer charges the mobile phone via the USB cable. When the user selects the option 1502, the interface of the resource manager of the computer only displays the file partition 1504 of the mobile phone and the PSSD partition 1503 is not displayed, and at the same time, the computer charges the mobile phone via the USB cable. When the user selects the option 1505, the interface of the resource manager of the computer does not display the PSSD partition 1503 and mobile phone file partition 1504. For example, at this moment, the computer only charges the mobile phone via the USB cable.

In some other examples, the above-mentioned options 1501, 1502, and 1505 can also be triggered separately. For example, when the user selects the option 1501 and does not select the options 1502 and 1505, only the PSSD partition 1503 is displayed in the interface of the resource manager of the computer, and the computer does not charge the mobile phone. When the user selects the option 1502 and does not select the options 1501 and 1505, only the mobile phone file partition 1504 is displayed in the interface of the resource manager of the computer, and the computer does not charge the mobile phone. When the user selects the option 1505 and does not select the options 1501 and 1502, the computer charges the mobile phone, but the PSSD partition 1503 and the mobile phone file partition 1504 are not displayed in the interface of the resource manager of the computer. As another example, when the user selects the option 1501 and option 1502 and does not select the option 1505, the PSSD partition 1503 and mobile phone file partition 1504 are displayed in the interface of the resource manager of the computer, and the computer does not charge the mobile phone. For another example, when the user selects the options 1501, 1502, and 1505 at the same time, the PSSD partition 1503 and mobile phone file partition 1504 are displayed in the interface of the resource manager of the computer, and the computer charges the mobile phone.

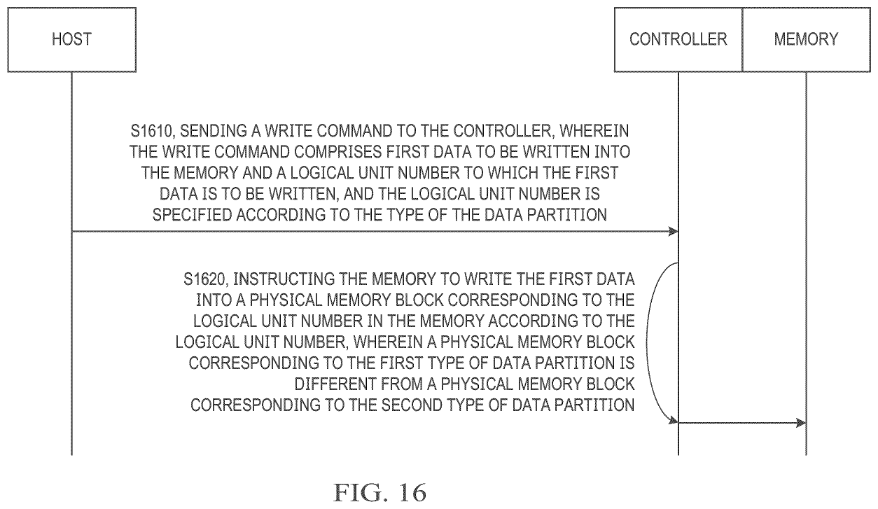

FIG. 16 is a flow chart of a method of operating a computer system according to an example of the present application. The method is applied to a computer system including a host, a controller, and a memory. The memory space of the memory is divided into at least two types of data partitions, the at least two types comprising: a first type corresponding to external data of an electronic device comprising the computer system; and a second type corresponding to internal data of the electronic device. For example, the computer system can be a computer system as shown in FIG. 8. As shown in FIG. 16, the method includes the following.

Operation 1610, sending, by the host, a write command to the controller, wherein the write command comprises first data to be written into the memory and a logical unit number to which the first data is to be written, and the logical unit number is specified according to the type of the data partition.

Operation 1620, instructing, by the controller, the memory to write the first data into a physical memory block corresponding to the logical unit number in the memory according to the logical unit number, wherein a physical memory block corresponding to the first type of data partition is different from a physical memory block corresponding to the second type of data partition.

In an example, the instructing, by the controller, the memory to write the first data into a physical memory block corresponding to the logical unit number in the memory according to the logical unit number comprises: determining, by the controller, the physical memory block corresponding to the logical unit number according to the logical unit number; and instructing, by the controller, the memory to write the first data into the physical memory block corresponding to the logical unit number.

In an example, the determining, by the controller, the physical memory block corresponding to the logical unit number according to the logical unit number, and instructing, by the controller, the memory to write the first data into the physical memory block corresponding to the logical unit number comprises: obtaining, by the controller, data attribute of the first data according to the logical unit number, wherein the data attribute is configured to indicate whether the first data is the external data of the electronic device or the internal data of the electronic device; determining, by the controller, the physical memory block corresponding to the logical unit number in the memory according to the data attribute; and instructing, by the controller, the memory to write the first data into the physical memory block corresponding to the logical unit number.

In an example, a correspondence between the logical unit number and the data attribute of the first data is predefined by a protocol; or the correspondence between the logical unit number and the data attribute of the first data is set when the memory space of the memory is configured as the at least two types of data partitions in the host.

In an example, the determining, by the controller, the physical memory block corresponding to the logical unit number in the memory according to the data attribute comprises: in a case where the data attribute is configured to indicate that the first data is the external data of the electronic device, determining, by the controller, at least one physical memory block satisfying a first condition in the memory as the physical memory block corresponding the logic unit number, the first condition comprising: the physical memory block is not full, and second data is not stored, wherein the second data is data in the second type of data partition; and in a case where the data attribute is configured to indicate that the first data is the internal data of the electronic device, determining, by the controller, at least one physical memory block satisfying a second condition in the memory as the physical memory block corresponding the logic unit number, the second condition comprising: the physical memory block is not full, and third data is not stored, wherein the third data is data in the first type of data partition.

In an example, a correspondence between the type of the data partition and a physical memory block where data in the data partition is located is a non-fixed configuration relationship.

In a case where the data attribute is configured to indicate that the first data is the external data of the electronic device, determining, by the controller, at least one physical memory block satisfying a first condition in the memory as the physical memory block corresponding the logic unit number comprises: in the case where the data attribute is configured to indicate that the first data is the external data of the electronic device, determining, by the controller, at least one physical memory block satisfying the first condition from all writable physical memory blocks of the memory as the physical memory block corresponding to the logical unit number.

In a case where the data attribute is configured to indicate that the first data is the internal data of the electronic device, determining, by the controller, at least one physical memory block satisfying a second condition in the memory as the physical memory block corresponding the logic unit number comprises: in the case where the data attribute is configured to indicate that the first data is the internal data of the electronic device, determining, by the controller, at least one physical memory block satisfying the second condition from all writable physical memory blocks of the memory as the physical memory block corresponding to the logical unit number.

In an example, a correspondence between the type of the data partition and a physical memory block where data in the data partition is located is a fixed configuration relationship.

In a case where the data attribute is configured to indicate that the first data is the external data of the electronic device, determining, by the controller, at least one physical memory block satisfying a first condition in the memory as the physical memory block corresponding the logic unit number comprises: in the case where the data attribute is configured to indicate that the first data is the external data of the electronic device, determining, by the controller, at least one physical memory block that is not full from individual physical memory blocks preconfigured for the first type of data partition as the physical memory block corresponding to the logical unit number.

In a case where the data attribute is configured to indicate that the first data is the internal data of the electronic device, determining, by the controller, at least one physical memory block satisfying a second condition in the memory as the physical memory block corresponding the logic unit number comprises: in the case where the data attribute is configured to indicate that the first data is the internal data of the electronic device, determining, by the controller, at least one physical memory block that is not full from individual physical memory blocks pre-configured for the second type of data partition as the physical memory block corresponding to the logical unit number.

In an example, the above method further includes: setting, by the controller, a data type of the first data according to the type of the data partition into which the first data is written, and wherein the data type is to manage the first data or the physical memory block where the first data is located.

In an example, the data type comprises: cold data; or hot data.

In an example, the above method further includes: in a case where the first type of data partition has been loaded, displaying, by the host, an unload control on an interactive interface; and in a case where a trigger operation on the unload control is received, unloading, by the host, the first type of data partition in an interface of a resource manager of the host.

In an example, the above method further includes: in a case where the first type of data partition has not been loaded, displaying, by the host, a load control on an interactive interface; and in a case where a trigger operation on the load control is received, loading, by the host, the first type of data partition in an interface of a resource manager of the host.

In an example, the above method further includes: in response to the electronic device being coupled to an external device via a Universal Serial Bus interface, displaying, by the host, a trigger control corresponding to the first type of data partition on an interactive interface; and in a case where a selection operation on the trigger control is received, allowing, by the host, the first type of data partition to be accessed at the external device side.

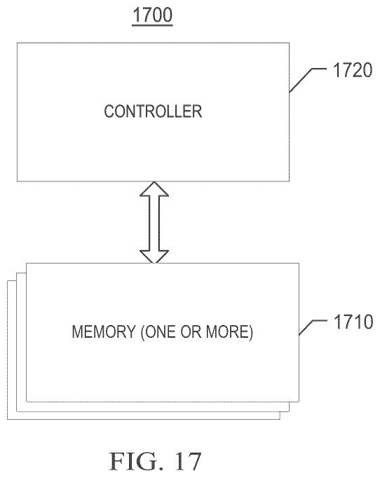

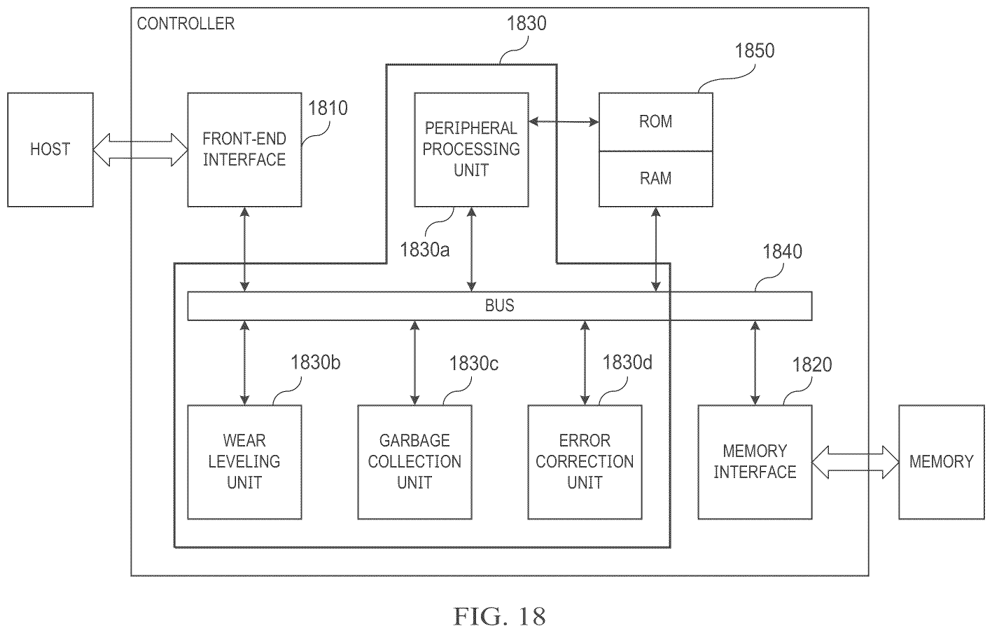

FIG. 17 is a structural block diagram of a memory system according to an example of the present application. As shown in FIG. 17, the memory system 1700 includes: one or more memories 1710, and a controller 1720 coupled to the memory 1710 and configured to control the memory 1710.

Memory system 1700 may be a mobile phone, desktop computer, laptop computer, tablet computer, vehicle computer, game console, printer, positioning device, wearable electronic device, smart sensor, virtual reality (VR) device, augmented reality (AR) device or any other suitable electronic device having storage therein, in whole or in part.

In some examples, the memory system 1700 may include a host and a memory subsystem, and the memory subsystem has one or more memories 1710 and a controller 1720. The host may be a processor of the electronic device (for example, a Central Processing Unit (CPU)) or a System on Chip (SoC) (for example, an Application Processor (AP)). The host may be configured to send data to memory 1710. Alternatively, the host may be configured to receive data from memory 1710.

According to some implementations, the controller 1720 is also coupled to the host. The controller 1720 may manage data stored in the memory 1710, and communicate with the host.

In some examples, the controller 1720 is designed to operate in a low duty-cycle environment, such as a Secure Digital (SD) card, Compact Flash (CF) card, Universal Serial Bus (USB) flash drive, or other media for use in electronic devices such as personal computers, digital cameras, mobile phones, and the like.

In some examples, the controller 1720 is designed to operate in a high duty-cycle environment a solid-state disk (SSD) or an embedded Multi Media Card (eMMC) used as data storage for mobile devices such as smartphones, tablets, and laptops, and enterprise storage arrays.

The controller 1720 may be configured to control operations of the memory 1710, such as read, erase, and program operations. The controller 1720 may also be configured to manage various functions regarding data stored or to be stored in the memory 1710, including but not limited to bad block management, garbage collection, logical-to-physical address translation, wear leveling, and the like. In some examples, the controller 1720 is further configured to process error correction code (ECC) of data read from or written to the memory 1710.

Controller 1720 may also perform any other suitable functions, such as formatting memory 1710. The controller 1720 may communicate with external devices according to a specific communication protocol.

The controller 1720 and the one or more memories 1710 may be integrated into various types of storage devices, e.g., included in the same package (e.g., Universal Flash Storage (UFS) package or eMMC package). For example, the memory system 1700 can be implemented and packaged into different types of terminal electronic products.

In an example, the controller 1720 and a single memory 1710 can be integrated into a memory card. Memory cards can include PC cards (Personal Computer Memory Card International Association, PCMCIA), CF cards, Smart Media (SM) cards, memory sticks, multimedia cards (MMC, RS-MMC, MMCmicro), SD cards (SD, miniSD, microSD, SDHC), UFS, etc. The memory card may also include a memory card connector that couples the memory card with the host.

In an example, the controller 1720 and the plurality of memories 1710 may be integrated into a solid state drive (SSD). In some implementations, at least one of the storage capacity or operating speed of the solid state drive is greater than that of the memory card.

The above-mentioned controller 1720 can be implemented as the controller 820 in the computer system shown in FIG. 8, and the memory 1710 can be implemented as the memory 830 in the computer system shown in FIG. 8. For example, memory space of the memory is divided into at least two types of data partitions, the at least two types comprising: a first type corresponding to external data of an electronic device comprising the computer system; and a second type corresponding to internal data of the electronic device. Correspondingly, the controller is configured to receive a write command, wherein the write command comprises first data to be written into the memory and a logical unit number to which the first data is to be written, and the logical unit number is specified according to the type of the data partition. The controller is further configured to instruct the memory to write the first data into a physical memory block corresponding to the logical unit number in the memory according to the logical unit number, wherein a physical memory block corresponding to the first type of data partition is different from a physical memory block corresponding to the second type of data partition.

It can be understood that the controller 1720 may perform all or part of the operations performed by the controller in the scheme shown in FIG. 16 above.

FIG. 18 is a schematic structural diagram of a controller according to an example of the present application. As shown in FIG. 18, the controller 1800 includes a front-end interface 1810, a memory interface 1820, a memory controller 1830 and a bus 1840.

The front-end interface 1810 may also be referred to as a Host I/F, which is connected to the host and used for communicating with the host.

The memory interface 1820 is connected to a memory (which may be a non-volatile memory), and is used to convert data exchange on the bus into data exchange conforming to the storage timing of the storage medium.

The memory controller 1830 is configured to control the functions of the entire controller, control the memory interface to correctly complete the data exchange between the memory and the bus, and be responsible for the management of interrupt signals and the like. In some examples, for example, the memory controller 1830 may be used to control functions such as data writing, data reading, garbage collection, wear leveling, and error correction.

In some examples, the memory controller 1830 may include a peripheral processing unit 1830a, a wear leveling unit 1830b, a garbage collection unit 1830c, and an error correction unit 1830d.

The peripheral processing unit 1830a can be used to implement functions such as mapping management, bad block management, and power failure recovery. The wear leveling unit 1830b is used to implement the wear leveling function of the memory. The garbage collection unit 1830c is used to implement the garbage collection function of the memory. The error correction unit 1830d is used to implement an error correction (error detection and correction) function. For example, the error correction unit 1830d may include an ECC circuit.

In some examples, the controller 1800 may further include a storage unit 1850. In some examples, the storage unit 1850 may include a read only memory (ROM) and a random access memory (RAM).

The read-only memory may be connected to the memory controller 1830, for example, connected to the peripheral processing unit 1830a in the memory controller 1830, and may be used to save firmware program and fixed configuration information of the controller 1800.

The random access memory can be connected to the front-end interface 1810, the memory interface 1820, and the memory controller 1830 via the bus 1840, and may be used for caching the data exchanged between the controller 1800 and the host or the memory, as well as data such as a part of configuration information of the controller 1800, etc.

In the example of the present application, memory space of the memory is divided into at least two types of data partitions. The at least two types include a first type corresponding to external data of an electronic device including a computer system, and a second type corresponding to internal data of the electronic device. The computer system includes the host, the controller 1800, and the memory. The front-end interface 1810 is configured to receive a write command. The write command includes first data to be written into the memory and a logical unit number to which the first data is to be written. The logical unit number is specified according to the type of the data partition. The memory controller 1830 is configured to instruct, by the memory interface 1820, the memory to write the first data into a physical memory block corresponding to the logical unit number in the memory according to the logical unit number, wherein the physical memory block corresponding to the first type of the data partition is different from the physical memory block corresponding to the second type of the data partition.

It can be understood that the controller 1800 may execute all or part of the operations performed by the controller in the method shown in FIG. 16 above.

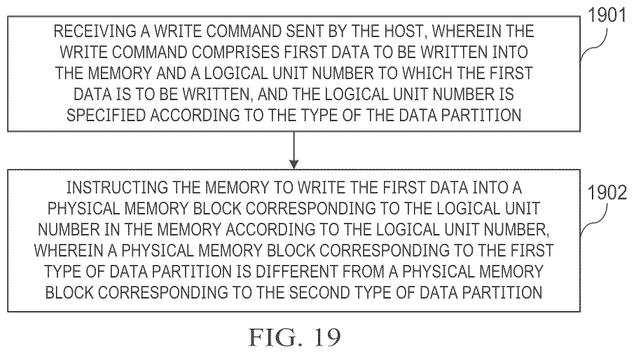

FIG. 19 is a flow chart of a method of operating a memory system according to another example of the present application. The memory system includes a controller and a memory, wherein memory space of the memory is divided into at least two types of data partitions, the at least two types comprising: a first type corresponding to external data of an electronic device comprising a computer system; and a second type corresponding to internal data of the electronic device. The computer system includes the above-mentioned memory system. The method can be executed by the controller. For example, the controller may be the controller 1800 as shown in FIG. 18. As shown in FIG. 19, the method includes the followings.

Operation 1901, receiving a write command, wherein the write command comprises first data to be written into the memory and a logical unit number to which the first data is to be written, and the logical unit number is specified according to the type of the data partition.

Operation 1902, instructing the memory to write the first data into a physical memory block corresponding to the logical unit number in the memory according to the logical unit number, wherein a physical memory block corresponding to the first type of data partition is different from a physical memory block corresponding to the second type of data partition.

It can be understood that the method shown in the example of the present application may include all or part of the operations performed by the controller in the method shown in FIG. 16 above.

An example of the present application provides a computer-readable storage medium having stored therein instructions that, when run on a controller, implement the method of operating the memory system provided by the example shown in FIG. 19. In some examples, the controller may be the controller 802 in the computer system as shown in FIG. 8, or the controller 1800 as shown in FIG. 18.

The example of the present application provides a computer-readable storage medium having stored therein instructions that, when run on the processor of the host, implement all or part of the operations executed by the host in the method of operating the computer system provided by the example shown in FIG. 16.

In the present application, the terms “first” and “second” are used for descriptive purposes only, and should not be construed as indicating or implying relative importance. The term “at least one” means one or more, and the term “plurality” means two or more, unless otherwise clearly defined.

The term “at least one of” in this application is only an association relationship describing associated objects, which means that there may be three relationships. For example, at least one of A or B may mean: A alone, both A and B, and B alone. In addition, the character “/” herein indicates that the contextual objects are in an “or” relationship.

The above is only examples of the application, and are not intended to limit the application. Any modifications, equivalent replacements, improvements, etc. made within the spirit and principles of the application shall be included within the protection range of the application.

What is claimed is:

1. A computer system, comprising:
a memory, wherein memory space of the memory is divided into at least two types of data partitions, the at least two types comprising: a first type corresponding to external data of an electronic device comprising the computer system; and a second type corresponding to internal data of the electronic device;
a host configured to send a write command to a controller, wherein the write command comprises first data to be written into the memory and a logical unit number (LUN) to which the first data is to be written, and the logical unit number is specified according to the type of the data partition; and
the controller, configured to instruct the memory to write the first data into a physical memory block corresponding to the logical unit number in the memory according to the logical unit number,
wherein a physical memory block corresponding to the first type of data partition is different from a physical memory block corresponding to the second type of data partition.

2. The computer system of claim 1, wherein the controller is configured to:
determine the physical memory block corresponding to the logical unit number according to the logical unit number; and
instruct the memory to write the first data into the physical memory block corresponding to the logical unit number.

3. The computer system of claim 2, wherein the controller is configured to:
obtain data attribute of the first data according to the logical unit number, wherein the data attribute is configured to indicate whether the first data is the external data of the electronic device or the internal data of the electronic device;
determine the physical memory block corresponding to the logical unit number in the memory according to the data attribute; and
instruct the memory to write the first data into the physical memory block corresponding to the logical unit number.

4. The computer system of claim 3, wherein:
a correspondence between the logical unit number and the data attribute of the first data is predefined by a protocol; or
the correspondence between the logical unit number and the data attribute of the first data is set when the memory space of the memory is configured as the at least two types of data partitions in the host.

5. The computer system of claim 3, wherein the controller is configured to:
in a case where the data attribute is configured to indicate that the first data is the external data of the electronic device, determine at least one physical memory block satisfying a first condition in the memory as the physical memory block corresponding the logic unit number, the first condition comprising: the physical memory block is not full, and second data is not stored, wherein the second data is data in the second type of data partition; and
in a case where the data attribute is configured to indicate that the first data is the internal data of the electronic device, determine at least one physical memory block satisfying a second condition in the memory as the physical memory block corresponding the logic unit number, the second condition comprising: the physical memory block is not full, and third data is not stored, wherein the third data is data in the first type of data partition.

6. The computer system of claim 5, wherein a correspondence between the type of the data partition and a physical memory block where data in the data partition is located is a non-fixed configuration relationship, and
the controller is configured to:
in the case where the data attribute is configured to indicate that the first data is the external data of the electronic device, determine at least one physical memory block satisfying the first condition from all writable physical memory blocks of the memory as the physical memory block corresponding to the logical unit number; and
in the case where the data attribute is configured to indicate that the first data is the internal data of the electronic device, determine at least one physical memory block satisfying the second condition from all writable physical memory blocks of the memory as the physical memory block corresponding to the logical unit number.

7. The computer system of claim 5, wherein a correspondence between the type of the data partition and a physical memory block where data in the data partition is located is a fixed configuration relationship, and
the controller is configured to:
in the case where the data attribute is configured to indicate that the first data is the external data of the electronic device, determine at least one physical memory block that is not full from individual physical memory blocks preconfigured for the first type of data partition as the physical memory block corresponding to the logical unit number; and
in the case where the data attribute is configured to indicate that the first data is the internal data of the electronic device, determine at least one physical memory block that is not full from individual physical memory blocks pre-configured for the second type of data partition as the physical memory block corresponding to the logical unit number.

8. The computer system of claim 1, wherein the controller is further configured to:
set a data type of the first data according to the type of the data partition into which the first data is written, and
wherein the data type is to manage the first data or the physical memory block where the first data is located.

9. The computer system of claim 1, wherein the host is further configured to:
in a case where the first type of data partition has been loaded, display an unload control on an interactive interface; and
in a case where a trigger operation on the unload control is received, unload the first type of data partition in an interface of a resource manager of the host.

10. The computer system of claim 1, wherein the host is further configured to:
in a case where the first type of data partition has not been loaded, display a load control on an interactive interface; and
in a case where a trigger operation on the load control is received, load the first type of data partition in an interface of a resource manager of the host.

11. The computer system of claim 1, wherein the host is further configured to:
in response to the electronic device being coupled to an external device via a Universal Serial Bus interface, display a trigger control corresponding to the first type of data partition on an interactive interface; and
in a case where a selection operation on the trigger control is received, allow the first type of data partition to be accessed at the external device side.

12. A method of operating a computer system, wherein the computer system comprises:
a host;
a controller; and
a memory, wherein memory space of the memory is divided into at least two types of data partitions, the at least two types comprising: a first type corresponding to external data of an electronic device comprising the computer system; and a second type corresponding to internal data of the electronic device,
wherein the method comprises:
sending, by the host, a write command to the controller, wherein the write command comprises first data to be written into the memory and a logical unit number to which the first data is to be written, and the logical unit number is specified according to the type of the data partition; and
instructing, by the controller, the memory to write the first data into a physical memory block corresponding to the logical unit number in the memory according to the logical unit number,
wherein a physical memory block corresponding to the first type of data partition is different from a physical memory block corresponding to the second type of data partition.

13. The method of claim 12, wherein the instructing, by the controller, the memory to write the first data into a physical memory block corresponding to the logical unit number in the memory according to the logical unit number comprises:
determining, by the controller, the physical memory block corresponding to the logical unit number according to the logical unit number; and
instructing, by the controller, the memory to write the first data into the physical memory block corresponding to the logical unit number.

14. The method of claim 13, wherein the determining, by the controller, the physical memory block corresponding to the logical unit number according to the logical unit number, and instructing, by the controller, the memory to write the first data into the physical memory block corresponding to the logical unit number comprises:
obtaining, by the controller, data attribute of the first data according to the logical unit number, wherein the data attribute is configured to indicate whether the first data is the external data of the electronic device or the internal data of the electronic device;
determining, by the controller, the physical memory block corresponding to the logical unit number in the memory according to the data attribute; and
instructing, by the controller, the memory to write the first data into the physical memory block corresponding to the logical unit number.

15. The method of claim 14, wherein,
a correspondence between the logical unit number and the data attribute of the first data is predefined by a protocol; or
the correspondence between the logical unit number and the data attribute of the first data is set when the memory space of the memory is configured as the at least two types of data partitions in the host.

16. The method of claim 14, wherein the determining, by the controller, the physical memory block corresponding to the logical unit number in the memory according to the data attribute comprises:
in a case where the data attribute is configured to indicate that the first data is the external data of the electronic device, determining, by the controller, at least one physical memory block satisfying a first condition in the memory as the physical memory block corresponding the logic unit number, the first condition comprising: the physical memory block is not full, and second data is not stored, wherein the second data is data in the second type of data partition; and
in a case where the data attribute is configured to indicate that the first data is the internal data of the electronic device, determining, by the controller, at least one physical memory block satisfying a second condition in the memory as the physical memory block corresponding the logic unit number, the second condition comprising: the physical memory block is not full, and third data is not stored, wherein the third data is data in the first type of data partition.

17. The method of claim 16, wherein a correspondence between the type of the data partition and a physical memory block where data in the data partition is located is a non-fixed configuration relationship, and
in a case where the data attribute is configured to indicate that the first data is the external data of the electronic device, determining, by the controller, at least one physical memory block satisfying a first condition in the memory as the physical memory block corresponding the logic unit number comprises:
in the case where the data attribute is configured to indicate that the first data is the external data of the electronic device, determining, by the controller, at least one physical memory block satisfying the first condition from all writable physical memory blocks of the memory as the physical memory block corresponding to the logical unit number; and
in a case where the data attribute is configured to indicate that the first data is the internal data of the electronic device, determining, by the controller, at least one physical memory block satisfying a second condition in the memory as the physical memory block corresponding the logic unit number comprises:
in the case where the data attribute is configured to indicate that the first data is the internal data of the electronic device, determining, by the controller, at least one physical memory block satisfying the second condition from all writable physical memory blocks of the memory as the physical memory block corresponding to the logical unit number.

18. The method of claim 16, wherein a correspondence between the type of the data partition and a physical memory block where data in the data partition is located is a fixed configuration relationship, and
in a case where the data attribute is configured to indicate that the first data is the external data of the electronic device, determining, by the controller, at least one physical memory block satisfying a first condition in the memory as the physical memory block corresponding the logic unit number comprises:
in the case where the data attribute is configured to indicate that the first data is the external data of the electronic device, determining, by the controller, at least one physical memory block that is not full from individual physical memory blocks preconfigured for the first type of data partition as the physical memory block corresponding to the logical unit number; and
in a case where the data attribute is configured to indicate that the first data is the internal data of the electronic device, determining, by the controller, at least one physical memory block satisfying a second condition in the memory as the physical memory block corresponding the logic unit number comprises:
in the case where the data attribute is configured to indicate that the first data is the internal data of the electronic device, determining, by the controller, at least one physical memory block that is not full from individual physical memory blocks pre-configured for the second type of data partition as the physical memory block corresponding to the logical unit number.

19. The method of claim 12, further comprising:
setting, by the controller, a data type of the first data according to the type of the data partition into which the first data is written, and
wherein the data type is to manage the first data or the physical memory block where the first data is located.

20. A memory system, comprising:
a memory, wherein memory space of the memory is divided into at least two types of data partitions, the at least two types comprising: a first type corresponding to external data of an electronic device comprising a computer system; and a second type corresponding to internal data of the electronic device, and wherein the computer system comprises the memory system; and
a controller configured to:
receive a write command, wherein the write command comprises first data to be written into the memory and a logical unit number to which the first data is to be written, and the logical unit number is specified according to the type of the data partition; and
instruct the memory to write the first data into a physical memory block corresponding to the logical unit number in the memory according to the logical unit number,
wherein a physical memory block corresponding to the first type of data partition is different from a physical memory block corresponding to the second type of data partition.
